(19) United States
(12) Patent Application Publication
(10) Pub. No.: US 2024/0240998 A1
(43) Pub. Date: Jul. 18, 2024

(54) METHOD FOR MEASURING FLUID TEMPERATURE IN AN ACOUSTIC-BASED PARTICLE MANIPULATION DEVICE

(71) Applicant: LUMICKS CA Holding B.V., Amsterdam (NL)

(72) Inventors: Douwe Kamsma, Amsterdam (NL); Felix Oswald, Amsterdam (NL)

(21) Appl. No.: 18/574,542

(22) PCT Filed: Jun. 27, 2022
(86) PCT No.: PCT/EP2022/067553

§ 371 Date: Dec. 27, 2023

(30) Foreign Application Priority Data
Jun. 30, 2021 (NL) 2028594

(51) Int. Cl. G01K 15/00; B01L 3/00; G01K 11/26; G05D 23/19

(52) U.S. Cl. CPC G01K 15/005; B01L 3/502761; G01K 11/26; G05D 23/1951; B01L 2200/0663; B01L 2300/0663; B01L 2400/0436

(57) ABSTRACT

A method is disclosed for measuring a temperature of a fluid in a holding space of an acoustic-based particle manipulation device. The method comprises performing a calibration. The calibration comprises measuring, using a reference temperature sensor, the temperature of the fluid to be a reference temperature value. The calibration also comprises determining a reference resonance frequency of the acoustic-based particle manipulation device having the fluid in its holding space at the reference temperature value. The method further comprises measuring the temperature of the fluid comprising determining a resonance frequency of the acoustic-based particle manipulation device and determining, based on the reference resonance frequency determined during the calibration and based on the determined resonance frequency, the temperature of the fluid to be a temperature value.

### CROSS-REFERENCE TO RELATED APPLICATION(S)

This Application is a Section 371 National Stage Application of International Application No. PCT/EP2022/067553, filed Jun. 27, 2022, and published as WO 2023/274951 A1 on Jan. 5, 2023, and further claims priority to Netherlands Patent Application No. 2028594, filed Jun. 30, 2021, the contents of which are hereby incorporated by reference in their entirety.

### FIELD OF THE INVENTION

This disclosure relates to a method for measuring a temperature of a fluid in a holding space of an acoustic-based particle manipulation device. In particular to such method wherein the temperature of the fluid is measured based on a calibration involving measuring a reference resonance frequency of the acoustic-based particle manipulation device when the fluid is at a reference temperature value. This disclosure further relates to a non-transitory computer-readable storage medium and acoustic-based particle manipulation device calibrated using the methods for measuring the temperature disclosed herein.

### BACKGROUND

Microscopic study and/or manipulation of small particles is an active field of research, in particular in case the small particles are biological specimens such as cells, organelles, few-cell bodies and the like. For biological specimens, biological processes are researched. Biological cells have an outer membrane. This membrane is the interface between the cell and its environment. The membrane therefore builds the platform for a variety of processes that involve membrane embedded biomolecules making physical contact with binding partners in the extracellular space.

Therefore, a number of techniques have been developed for studying cellular and subcellular processes by interaction with the cellular membrane, and techniques have been devised to quantify the components of the cell surface to obtain information on the specific cell type (for example to determine the type of breast cancer).

A particularly suitable technique for manipulating and/or studying small particles and in particular cellular bodies is employing of acoustic forces, for example in order to test the adhesion of particles to other particles and/or to sort cells based on their acoustic contrast factor. It is noted that the use of acoustic forces to manipulate micron-sized particles and cells is known in general. E.g. WO 2014/200341 provides an example of an acoustic wave system for use in studying biomolecules attached to microbeads; WO 2018/083193 discloses a method, system and sample holder for manipulating and/or investigating cellular bodies; and WO 2019/212349 discloses a method for probing mechanical properties of cellular bodies. Further, G. Thalhammer et al. “Acoustic force mapping in a hybrid acoustic optical micromanipulation device supporting high resolution optical imaging”, Lab Chip 16:1523 (2016) is noted, and a summary of current research in acoustofluidics can be found in V. Marx, “Biophysics: using sound to move cells”, Nature Methods, 12(1):41 (2015). Reviews are also presented in H. Mulvana et al., “Ultrasound assisted particle and cell manipulation on-chip”, Adv. Drug Del. Rev. 65(11-12): 1600 (2013); and M. Evander and J. Nilsson. “Acoustofluidics 20: Applications in acoustic trapping”, Lab on a Chip, 12:4667 (2012). Other popular means to study and/or manipulate cells or particles are for example optoelectronic tweezers based on dielectrophoresis (U.S. Pat. No. 7,612,355B2) or optical tweezers (U.S. Pat. No. 7,049,579B2).

Typically, experiments are performed at predefined temperatures. Therefore, it has to be ensured that in particular the fluid in the holding space containing the small particles under investigation has the predefined temperature. For example, biological particles are often studied at a body temperature of e.g. a human. However, it has proven a challenge to accurately measure the temperature of the fluid during an experiment. It is typically not possible to position a reference temperature sensor within the holding space. Inserting a reference temperature sensor into the holding space may significantly limit the view on the active area in the holding space. Additionally or alternatively, such reference sensor in the holding space may interfere in some way with the active area. To illustrate, it may interfere with the acoustic resonance structures, with electrodes used for (di)electrophoresis or the sensor may interfere with the sample itself or the interactions between the sample and the active area. Hence, during an experiment, the temperature can only be probed in proximity of the holding space. However, such temperature measurement only yields, at best, an estimate of the actual fluid temperature in the active area of the acoustic-based particle manipulation device. Such estimation should accurately model the temperature gradient that is present in the materials between the heater structures and the holding space. Especially if local, on chip heating or cooling structures are used to control the fluid temperature, a strong temperature gradient will arise. The local nature of such structures will inevitably introduce a temperature gradient in the chip, i.e. the chip will typically not be in thermal equilibrium. Modeling such temperature gradient, especially is if it is relatively strong, is not trivial. Due to unknown material property variations or manufacturing tolerances, for example, it may not even be possible to make models of such temperature gradients with sufficient accuracy.

In light of the above, there is a need in the art for improved methods that enable more accurate temperature measurements of the fluid in acoustic-based particle manipulation devices.

### SUMMARY

To that end, a method is disclosed for measuring a temperature of a fluid in a holding space of an acoustic-based particle manipulation device. The method comprises performing a calibration. The calibration comprises measuring, using a reference temperature sensor, the temperature of the fluid to be a reference temperature value. The calibration also comprises determining a reference resonance frequency of the acoustic-based particle manipulation device having the fluid in its holding space at the reference temperature value. The method further comprises measuring the temperature of the fluid comprising determining a resonance frequency of the acoustic-based particle manipulation device and determining, based on the reference resonance frequency determined during the calibration and based on the determined resonance frequency, the temperature of the fluid to be a temperature value.

The inventors have found that resonance frequency measurements can be used for measuring the temperature of the fluid in the holding space. By measuring the resonance frequency while the fluid in the acoustic-based particle manipulation device has the reference temperature value, the measured reference resonance frequency is linked to the reference temperature value. It should be appreciated that this correlation may be specific for the specific acoustic-based particle manipulation device involved in the calibration. For another device the correlation between resonance frequency and fluid temperature may be different. This may be due to e.g. manufacturing tolerances of temperature control structures or other parts of the device. In case the acoustic-based particle manipulation device is defined as part of a system it may also depend on the way the device is mounted, e.g. on the thermal contact with the rest of the system.

Based on the link between resonance frequency and fluid temperature, the temperature of the fluid during an actual experiment can be measured simply by measuring the resonance frequency of the acoustic-base particle manipulation device. To illustrate, the reference temperature as measured by the reference temperature sensor may be 35 degrees Celsius and the reference resonance frequency that is measured while the fluid is at 35 degrees Celsius, is 7600 kHz. If thereafter, during an actual experiment, the resonance frequency of the device is measured to be 7600 kHz, it can be concluded that the fluid during the experiment is indeed 35 degrees Celsius. If, however, the resonance frequency has another value, for example 7605 KHZ, then it can be concluded that the temperature of the fluid is not 35 degrees Celsius. Such method of measuring the temperature of the fluid does not involve inserting a temperature sensor in the holding space, which is often not possible or, at least, highly undesired, as explained in the Background section. Thus, the method disclosed herein provides an improved way of measuring the temperature of the fluid without having to rely on models describing the temperature gradient in the acoustic-based particle manipulation device and without having to insert a temperature sensor into the holding space.

Of course, based on the temperature as measured using the methods disclosed herein, any temperature control system for heating and/or cooling the fluid can be controlled. If the temperature is measured to have a higher value than desired, then such temperature control system may be controlled to lower the temperature of the fluid. Vice versa, if the temperature is measured to have a lower value than desired, then such temperature control system may be controlled to increase the temperature of the fluid.

The acoustic-based particle manipulation device typically comprises an acoustic wave generator, such as an oscillator, which may comprise a transducer for converting an electrical driving signal such as an oscillating voltage, into an acoustic signal in the acoustic-based particle manipulation device, the acoustic signal providing a, preferably standing, acoustic wave in the holding space. The acoustic wave may be an ultrasonic acoustic wave, e.g. having a frequency in a range of 1-30 MHz, preferably in a range 5-20 MHz. Such acoustic wave generator, especially when driven by high-power electrical signals for generating strong acoustic forces on particles, may generate heat that eventually dissipates into the holding space herewith heating the fluid. By accurately measuring the temperature of the fluid during an experiment, it can for example be verified that the temperature of the fluid does not rise too much because of such heat.

The method may comprise providing a driving signal to the acoustic wave generator with a single frequency or with a (periodic or aperiodic) modulated frequency such as one or more of a sum of plural frequencies, a frequency sweep and a chirp. Also, in some cases driving signals of different waveforms may be applied and/or combined with other waveforms (sinusoidal, triangular, saw tooth, etc.).

A resonance frequency is in principle a system parameter. However, resonance conditions and therewith resonance frequencies tend, in practice, to differ between individual acoustic-based particle manipulation devices, due to manufacturing variations, and not to be constant but to depend on several circumstances, in particular manufacturing and/or age of the device and/or circumstances such as sample fluid composition including presence of occasional gas bubbles, temperature, density of suspended particles/cellular bodies, etc., all or some of which may vary. Since fluid composition influences the resonance frequency, the fluid that is inside the holding space during the calibration is preferably the same as the fluid that is inside the holding space when the temperature of the fluid is measured to be said temperature value. In an embodiment, the fluid is a buffer solution, such as water-based salt solution, such as a phosphate-buffered saline solution.

Preferably, any measurement of a property of the acoustic-based particle manipulation device, such as the temperature of the fluid in the holding space or the resonance frequency of the acoustic-based particle manipulation device, is performed while the acoustic-based particle manipulation device is in an equilibrium state, for example in the sense that the temperature at any position in the acoustic-based particle manipulation device is substantially constant.

The calibration may comprise heating or cooling the fluid to the reference temperature value and then measuring the temperature of the fluid to be the reference temperature value using the reference temperature sensor. Such heating or cooling during calibration is preferably performed using another temperature control system than the temperature control system that is optionally comprised by the acoustic-based particle manipulation device. In an example, such heating or cooling during the calibration is performed by inserting the device into an oven that is kept at substantially the reference temperature value such that after some time period the entire device, including the fluid inside the holding space, is substantially at the reference temperature value. In such case, the reference temperature sensor may simply be a temperature sensor that sits in the oven yet remote from the acoustic-based particle manipulation device during the calibration.

Alternatively, the reference temperature sensor may be configured to measure the temperature of the fluid based fluorescent thermometry or other optical thermometry methods, such as described in Qin, T., Liu et al. (2018); Organic fluorescent thermometers: Highlights from 2013 to 2017. TrAC—Trends in Analytical Chemistry, 102 (March), 259-271.

In an embodiment, the reference resonance frequency and the resonance frequency and, optionally, the second reference resonance frequency referred to below and, optionally, the second resonance frequency referred to below are associated with a resonance of a subsystem of the acoustic-based particle manipulation device, wherein the fluid in the holding space is part of said subsystem. Unless stated otherwise, any resonance frequency of the acoustic-based particle manipulation device may be understood to be associated with a resonance of a subsystem of the acoustic-based particle manipulation device, the fluid in the holding space being part of said subsystem.

The resonance frequencies referred to herein are typically between 7700 kHz-9700 KHz.

Typically, an acoustic-based particle manipulation device has multiple resonance frequencies. The inventors have found that there are at least two types of resonances, namely resonances that are created in the fluid, within the holding space, also referred to as “channel resonances”, and resonances that are created in areas next to the holding space, also referred to as “shoulder resonances”. When a channel resonance occurs, the fluid is part of the resonant system, i.e. of the system that exhibits resonant behavior. Typically, the resonant system for channel resonance comprises not only the fluid within the holding space, but also respective parts of top glass layer and bottom glass layer that at least partially form the holding space, such as respective parts of glass layers 3A and 3B indicated in FIG. 2A. On the other hand, when shoulder resonances occur, the resonant system typically does not comprise the fluid within the holding space. Thus, typically, with shoulder resonances, substantially no resonances are created in the fluid. The inventors observed that shoulder resonances are substantially independent of presence/absence of fluid in the holding space whereas channel resonances disappear in the absence of a fluid.

Further, the inventors found that in the relevant temperature range, changes in “shoulder-resonance” frequencies are negligible compared to changes of resonance frequency of channel resonance. Hence, the change in temperature dependent channel-resonance frequency effectively originates from the fluid only and therefore can be used as a direct measurement of the fluid temperature.

In an embodiment, performing the calibration further comprises heating or cooling the fluid to a second reference temperature value and measuring, using the reference temperature sensor, the temperature of the fluid to be the second reference temperature value. Such embodiment also comprises determining a second reference resonance frequency of the acoustic-based particle manipulation device having the fluid in its holding space at the second reference temperature value. Herein, determining the temperature of the fluid to be the temperature value is performed based on the determined reference resonance frequency and based on the determined second reference resonance frequency and based on the determined resonance frequency. The second reference temperature value may be higher or lower than said reference temperature value.

Thus, in this embodiment, at least two fluid temperature vs resonance frequency points are measured. This enables to determine the temperature with greater accuracy. In principle, the more such points are measured, the more accurate the dependence between fluid temperature and resonance frequency can be determined, and, hence, the more accurate the fluid temperature can be measured based on such calibration. It should be appreciated that heating or cooling the fluid to a reference temperature value is preferably performed using another temperature control system than the temperature control system that is optionally comprised by the acoustic-based particle manipulation device and that is further described below.

Of course, more than two fluid temperature vs resonance frequency points may be measured. In an embodiment, the method comprises repeatedly performing the sequence of steps (i)-(iii):
(i) heating or cooling the fluid to a k^{th} reference temperature value, and
(ii) measuring, using the reference temperature sensor, the temperature of the fluid to be the k^{th} reference temperature value, and
(iii) determining a k^{th} reference resonance frequency of the acoustic-based particle manipulation device having the fluid in its holding space at the k^{th} reference temperature value.

Herein, k is an integer number counting the number of iterations of the sequence. The sequence of steps (i)-(iii) may be repeated any number of times, for example, at least twice, at least three times, at least four times, at least five times, at least six times, at least seven times, at least eight times, at least nine times, at least ten times, et cetera.

In such embodiment, determining the temperature of the fluid to be the temperature value may then be performed based on any, e.g. all, of the reference resonance frequencies as determined during the different iterations.

In an embodiment, the method keeping an environment at the reference temperature value and heating or cooling the fluid to the reference temperature comprises inserting the acoustic-based particle manipulation device in said environment, such as an oven and/or incubator and/or refrigerator, so that the temperature of the fluid after some time period has the reference temperature value. Of course, the fluid may be brought to any reference temperature using such temperature controlled environment.

The environment is for example the internal space of an oven and/or incubator and/or refrigerator. As said, for heating or cooling the fluid during a calibration to a reference temperature, another temperature control system is used than the temperature control system that the acoustic-based particle manipulation device comprises. After said time period, e.g. after at least ten minutes, the acoustic-based particle manipulation device may have reached an equilibrium state, e.g. in the sense that the entire acoustic-based particle manipulation device is substantially at the reference temperature value. This is advantageous in that the fluid temperature can be accurately measured simply by measuring the temperature of the environment using the reference temperature sensor. In this embodiment, the reference temperature sensor can be positioned relatively remote from the acoustic-based particle manipulation device, yet in the environment.

Thus, in an embodiment, measuring the temperature of the fluid to be the reference temperature value and/or the second reference temperature value comprises measuring, using the reference temperature sensor, the temperature of said environment to be the reference temperature value and/or the second reference temperature value. Of course, any other reference temperature value can be measured in the same way.

In an embodiment, determining the temperature of the fluid to be the temperature value comprises determining a dependence between fluid temperature and resonance frequency of the acoustic-based particle manipulation device based on the reference resonance frequency and the second reference resonance frequency and, based on the determined resonance frequency and based on said dependence, determining the temperature of the fluid.

This embodiment enables to determine the temperature of the fluid over a wide range of temperature without having to measure, during calibration, numerous reference resonance frequency vs reference temperature value points.

This embodiment may comprise interpolating and/or extrapolating measured fluid temperature vs resonance frequency points. Such interpolating and/or extrapolating may comprise fitting a functions, such as a polynomial with any order of parameters, to the measured reference resonance frequency vs reference temperature value points.

In an embodiment, determining the reference resonance frequency and/or the second reference resonance frequency and/or the resonance frequency and/or the second resonance frequency comprises providing a driving signal to the holding space for generating an acoustic wave in the holding space, varying a frequency of the driving signal, and determining that the acoustic-based particle manipulation device exhibits a resonance frequency at respectively the reference resonance frequency and/or the second reference resonance frequency and/or the resonance frequency and/or the second resonance frequency.

Thus, a frequency sweep may be performed to find the frequencies at which the acoustic-based particle manipulation device resonates. Such resonance frequencies may be found by monitoring the conductance, which will be explained in more detail below.

For acoustic particle manipulation, standing acoustic waves may be used and one or more resonance frequencies for effective generation thereof may be determined in various ways. Calculated resonance frequencies tend not to be sufficiently accurate in practice. Practical determination of a resonance frequency may comprise performing a frequency sweep over a range of frequencies comprising at least one resonance frequency and detecting the at least one resonance frequency. System behavior may then be further studied employing frequencies in a comparably narrow frequency range about the resonance frequency.

In an embodiment, a power of the driving signal is kept relatively low while varying the frequency of the driving signal in order to prevent heat caused by the driving signal from heating the fluid and herewith substantially distorting the calibration.

Heat caused by the driving signal, which may be heat generated by an acoustic wave generator, such as a transducer, in response to receiving the driving signal, may distort the calibration. Hence, this embodiment improves the accuracy of the calibration.

In an embodiment, the acoustic-based particle manipulation device comprises a temperature control system for heating and/or cooling the fluid in the holding space. Such embodiment comprises heating or cooling the fluid in the holding space to said temperature value using the temperature control system by providing a control signal to the temperature control system and then performing the step of measuring the temperature of the fluid to be the temperature value. Such embodiment also comprises associating said control signal with the temperature value.

This embodiment is effectively a method for calibrating the temperature control system. To illustrate, if the temperature of the fluid has to be said temperature value during an actual experiment, then, based on the association between the temperature value and the control signal, it can be determined that the control signal will have to be applied to the temperature control system. Advantageously, this embodiment uses an indirect way of calibrating the temperature control system, namely via the resonance frequency of the acoustic-based particle manipulation device. This allows to, during calibration, heat the fluid using another temperature control system than the to-be-calibrated temperature control system. Using such other temperature control system may allow to measure the temperature of the fluid in a more straightforward manner than would be possible if the temperature control system of the acoustic-based particle manipulation device itself would be used. To illustrate, the other temperature control system may simply be an oven, which would allow the temperature of the fluid to be measured by simply measuring, when the acoustic-based particle manipulation device has reached an equilibrium state, the temperature inside the oven.

In this embodiment, determining the resonance frequency of the acoustic-based particle manipulation device for determining that the fluid is at said temperature value may be performed while having the control signal applied to its temperature control system.

The temperature control system of the device may comprise one or more heater (or cooler) structures. Such heater structures may be at least partially integrated into the device. Additionally or alternatively, such one or more heater or cooler structures may be applied onto the device.

Preferably, only the temperature control system of the device itself is used, for example only its one or more heater structures are used, to heat the fluid to said temperature value and no other heat sources. This ensures that the temperature control system is calibrated accurately, i.e. that the fluid will actually be at the temperature value upon providing the control signal to the temperature control device.

The one or more heater structures may be microheater structures. In particular, the one or more heater structures may be a heating wire forming a heating track on a printed circuit board (PCB).

The temperature control system may be configured to locally heat and/or cool the acoustic-based particle manipulation device (herewith heating and/or cooling, respectively, the fluid in the holding space) in the sense that the temperature control system creates a temperature gradient in the acoustic-based particle manipulation device.

Preferably, in this embodiment, also the environmental temperature, i.e. the temperature of the environment in which the device is present when the resonance frequency (and thus the fluid temperature) is measured, is associated with the control signal. The environmental temperature may namely influence for example how much heat should be generated by the temperature control system for having the fluid reach some desired temperature value.

In an example, during the calibration the reference temperature was measured by the reference temperature sensor to be 37 degrees Celsius and the associated reference resonance frequency 7610 KHz. If then later 17 Watt with a duty cycle of 16% (effectively 2.72 Watt) is applied to the one or more heater structures, and the resonance frequency is measured to be 7610 KHZ, then it can be concluded that a 17 Watt control signal with a duty cycle of 16% leads to a temperature of 37 degrees Celsius of the fluid. Subsequently, if during an actual experiment a fluid temperature of 37 degrees Celsius is desired, then the control signal may be selected as such based on the, optionally stored, association between control signal and 37 degrees Celsius.

In an embodiment, wherein the acoustic-based particle manipulation device comprises a temperature control system and wherein one or more temperature values are associated with one or more respective control signals, the temperature control system can be controlled directly. Based on a desired temperature value of the fluid, the appropriate control signal is easily selected.

In an embodiment, the method comprises heating or cooling the fluid in the holding space to a second temperature value using the temperature control system by providing a second control signal to the temperature control system and then measuring the temperature of the fluid comprising determining a second resonance frequency of the acoustic-based particle manipulation device and determining, based on the determined reference resonance frequency during the calibration, and optionally based on any other reference resonance frequency determined during the calibration, and based on the determined second resonance frequency, the temperature of the fluid to be the second temperature value. Such embodiment also comprises associating the second control signal with the second temperature value.

Thus, in this embodiment, multiple control signals are respectively associated with multiple temperature values. Such association allows to determine, based on a desired temperature value of the fluid, the appropriate control signal that is to be provided to the temperature control system. Of course, more than two control signal vs temperature value may be obtained in this manner. In an embodiment, the method comprises repeatedly performing the sequence of steps (i)-(iii):
(i) heating or cooling the fluid in the holding space to a k^{th} temperature value using the temperature control system by providing a k^{th} control signal to the temperature control system, and
(ii) measuring the temperature of the fluid comprising determining a k^{th} resonance frequency of the acoustic-based particle manipulation device and determining, based on the determined reference resonance frequency during the calibration, and optionally based on any other reference resonance frequency determined during the calibration, and based on the determined k^{th} resonance frequency, the temperature of the fluid to be the k^{th} temperature value, and
(iii) associating the k^{th} control signal with the k^{th} temperature value.

Herein, k is an integer number counting the number of iterations of the sequence. The sequence of steps (i)-(iii) may be repeated any number of times, for example, at least twice, at least three times, at least four times, at least five times, at least six times, at least seven times, at least eight times, at least nine times, at least ten times, et cetera.

It should be appreciated that in principle each control signal differs from all control signals.

In an embodiment, a parameter of said control signal, such as the control signal's voltage and/or current and/or electrical power and/or duty cycle, has a first value. In this embodiment, the same parameter of the second control signal has a second value different from the first value. In this embodiment, the method further comprises, based on the temperature value and on the determined second temperature value, determining a dependence between the parameter and the fluid temperature.

This embodiment is advantageous in that the one or more heater structures of the acoustic-based particle manipulation device can be easily calibrated for a large temperature range.

In an embodiment, the method comprises determining a dependence between fluid temperature and control signal based on the first control signal and second control signal.

In general, determining a dependence between fluid temperature and a signal, whether it is a control signal or signal as output by a temperature sensor, may comprise determining a dependence between fluid temperature and one or more parameters of such signal, e.g. the signal's voltage and/or current and/or power, etc.

Such dependence is preferably also determined based on the temperature values associated with the control signals.

The determined dependence between the parameter and the fluid temperature may be stored, preferably in association with a device identifier and the temperature of the environment during the measurement of the temperature value, on a non-transitory computer-readable storage medium, which may be embodied with the acoustic-based particle manipulation device or may be stored externally to the device e.g. in a database.

In an embodiment, the acoustic-based particle manipulation device comprises a temperature sensor for measuring the temperature at a position outside of the holding space, preferably said position being in or on the acoustic-based particle manipulation device. In such embodiment, the method may comprise receiving an output signal from the temperature sensor indicative of the temperature at said position when said step of determining the resonance frequency of the acoustic-based particle manipulation device is performed. Such embodiment comprises associating the output signal with the temperature value.

This embodiment is effectively a method for calibrating such temperature sensor. Advantageously, if the temperature sensor is calibrated in this manner, then it is no longer required to use models describing the temperature gradients in the acoustic-based particle manipulation device. Preferably, in this embodiment, also the environmental temperature, i.e. the temperature of the environment in which the device is present when the resonance frequency (and thus the fluid temperature) is measured, is associated with the output signal. The environmental temperature may namely influence for example the temperature gradient in the device. As a consequence, the temperature sensor may measure different temperatures at said position while the fluid temperature is the same.

In an embodiment wherein the device comprises a temperature control system for heating and/or cooling the fluid in the holding space, the method may comprise heating or cooling the fluid in the holding space to said temperature value using the temperature control system, and then performing said step of determining the resonance frequency of the acoustic-based particle manipulation device.

Such heating or cooling may be performed by providing a control signal to the temperature control system. In such case, the embodiment may also comprise associating the control signal with the temperature value. This embodiment is especially advantageous in that the temperature control system typically creates a temperature gradient in the device. Hence, the temperature that is measured by the temperature sensor, because the sensor is positioned outside of the holding space, is not the temperature of the fluid. However, the temperature of the fluid can be measured using the method disclosed. Therefore, calibration of the temperature sensor is still possible.

As said, in an embodiment, the acoustic-based particle manipulation device comprises a temperature control system for heating and/or cooling the fluid in the holding space. If this is the case, then the method may comprise heating or cooling the fluid in the holding space to a second temperature value using the temperature control system. Such embodiment further comprises measuring the temperature of the fluid comprising determining a second resonance frequency of the acoustic-based particle manipulation device and determining, based on the determined reference resonance frequency during the calibration, and optionally based on any other reference resonance frequency determined during the calibration, and based on the determined second resonance frequency, the temperature of the fluid to be the second temperature value. Such embodiment also comprises receiving a second output signal from the temperature sensor indicative of the temperature at said position when said step of determining the second resonance frequency of the acoustic-based particle manipulation device is performed and associating the second output signal with the second temperature value.

Thus, in this embodiment, multiple output signals of the temperature sensor are respectively associated with multiple temperature values. Of course, more than two output signal vs temperature value may be obtained in this manner. In an embodiment, the method comprises repeatedly performing the sequence of steps (i)-(iv):
(i) heating or cooling the fluid in the holding space to a k^{th} temperature value using the temperature control system, and
(ii) measuring the temperature of the fluid comprising determining a k^{th} resonance frequency of the acoustic-based particle manipulation device and determining, based on the determined reference resonance frequency during the calibration, and optionally based on any other reference resonance frequency determined during the calibration, and based on the determined k^{th} resonance frequency, the temperature of the fluid to be the second temperature value, and
(iii) receiving a k^{th} output signal from the temperature sensor indicative of the temperature at said position when said step of determining the k^{th} resonance frequency of the acoustic-based particle manipulation device is performed, and
(iv) associating the k^{th} output signal with the k^{th} temperature value.

Herein, k is an integer number counting the number of iterations of the sequence. The sequence of steps (i)-(iv) may be repeated any number of times, for example, at least twice, at least three times, at least four times, at least five times, at least six times, at least seven times, at least eight times, at least nine times, at least ten times, et cetera.

Of course, in each step (iv) any control signal applied to the temperature control system for bringing the fluid temperature to the k^{th} temperature value may also be associated with the k^{th} temperature value.

In an embodiment, the method comprises determining a dependence between fluid temperature and temperature sensor output signal based on the first output signal and second output signal.

Such dependence is preferably also determined based on the temperature values associated with the output signals.

The determined dependence between the temperature sensor output signal and the fluid temperature may be stored, preferably in association with a device identifier and the temperature of the environment during the measurement of the temperature value, on a non-transitory computer-readable storage medium, which may be embodied with the acoustic-based particle manipulation device or may be stored externally to the device e.g. in a database.

In an embodiment, the method comprises storing on a non-transitory computer-readable storage medium
the control signal in association with the temperature value, and/or
the second control signal in association with the second temperature value, and/or
the output signal in association with the temperature value, and/or
the second output signal in association with the second temperature value, and/or
any of the determined dependence between fluid temperature and control signal as described herein,
any of the determined dependence between fluid temperature and temperature sensor output signal as described herein.

In general, storing a signal, whether it is a control signal or output signal, with a temperature value may be understood to comprise storing on a non-transitory computer-readable storage medium an indication of one or more values of respective one or more parameters of the signal, such as the signal's voltage and/or current and/or electrical power, in association with an indication of the temperature value.

Preferably, these items are stored also in association with a device identifier and/or with the temperature of the environment during the measurement of the temperature value and, optionally, of the second temperature value. The environment as used herein may be understood to refer to the environment surrounding the acoustic-based particle manipulation device.

Associating the control signal with the temperature value may comprise storing on a non-transitory computer-readable storage medium an indication of one or more values of respective one or more parameters of the control signal, such as the control signal's voltage and/or current and/or electrical power, in association with an indication of the temperature value.

Associating the second control signal with the second temperature value may comprise storing on the computer-readable storage medium an indication of one or more values of respective one or more parameters of the second control signal, such as the second control signal's voltage and/or current and/or electrical power, in association with an indication of the second temperature value.

Associating the output signal with the temperature value may comprise storing on a computer-readable storage medium an indication of one or more values of respective one or more parameters of the output signal, such as the output signal's voltage and/or current and/or electrical power, in association with an indication of the temperature value.

Associating the second output signal with the second temperature value may comprise storing on the computer-readable storage medium an indication of one or more values of respective one or more parameters of the second output signal, such as the second output signal's voltage and/or current and/or electrical power, in association with an indication of the second temperature value.

More generally speaking, associating a signal, whether it is a control signal or output signal, with a temperature value may comprise storing on a computer-readable storage medium an indication of one or more values of respective one or more parameters of the signal, such as the signal's voltage and/or current and/or electrical power, in association with an indication of the temperature value.

It should be appreciated that for example the output signal's voltage may be stored in the form of an offset voltage from a reference voltage. To illustrate, it may be that the voltage of the output signal is 1.95 V for a fluid temperature of 37 degrees Celsius. However, if a standard temperature sensor is used, that has not yet been calibrated with the methods described herein, this standard temperature sensor would perhaps show a higher temperature on its display, e.g. 38 degrees Celsius, when it outputs a voltage of 1.95 V. Further, in this example, the standard temperature sensor would show on its display a temperature of 37 degrees Celsius, when its output voltage would be 1.94 V. In such case, the output signal's voltage of 1.95 V may be represented by an offset 0.01 V. The output signal's voltage is namely 0.01 V higher than would be the case if the standard temperature sensor would indeed be positioned inside the holding space and would correctly measure the fluid temperature.

In an embodiment, the acoustic-based particle manipulation device comprises said computer-readable storage medium.

One aspect of this disclosure relates to a method for calibrating an acoustic-based particle manipulation device. This method comprises performing any of the calibrations described herein, thus measuring one or more reference temperature value—reference resonance frequency pairs, and storing these measured pairs on a non-transitory-computer readable storage medium. If more than one reference temperature value—reference resonance frequency pair is measured, optionally, a dependence between fluid temperature and resonance frequency of the acoustic-based particle manipulation device is determined based on these measured pairs, which dependence can be stored on a non-transitory computer-readable storage medium.

One aspect of this disclosure relates to a non-transitory computer-readable storage medium that is obtainable by any of the methods described herein, in particular by any method described herein that involves storing data on a computer-readable storage medium.

One aspect of this disclosure relates to a computer-implemented method comprising
obtaining reference data, the reference data indicating for an acoustic-based particle manipulation device comprising a holding space containing a fluid, for one or more reference temperatures of the fluid one or more respective reference resonance frequencies, and
obtaining measurement data, the measurement data indicating one or more measured resonance frequencies of the acoustic-based particle manipulation device, and
determining, based on the reference data, for each of the one or more measured resonance frequencies indicated by the measurement data, a respective temperature of the fluid.

One aspect of this disclosure relates to a non-transitory computer-readable storage medium obtainable by performing any of the methods disclosed herein that comprises storing data on a computer-readable storage medium.

One aspect of this disclosure relates to an acoustic-based particle manipulation device comprising one or more heater structures that are configured to heat a fluid in a holding space of the acoustic-based particle manipulation device, wherein the one or more heater structures have been calibrated using any of the methods described herein.

One aspect of this disclosure relates to an acoustic-based particle manipulation device comprising a temperature sensor for measuring the temperature at a position outside of the holding space, preferably said position being in or on the acoustic-based particle manipulation device, wherein the temperature sensor has been calibrated using any of the methods described herein.

One aspect of this disclosure relates to a computer comprising a
a computer readable storage medium having computer readable program code embodied therewith, and
a processor, preferably a microprocessor, coupled to the computer readable storage medium, wherein responsive to executing the computer readable program code, the processor is configured to perform the method according to one or more of the preceding claims 1-xx.

One aspect of this disclosure relates to a computer program or suite of computer programs comprising at least one software code portion or a computer program product storing at least one software code portion, the software code portion, when run on a computer system, being configured for executing the any of the methods disclosed herein.

One aspect of this disclosure relates to a non-transitory computer-readable storage medium storing at least one software code portion, the software code portion, when executed or processed by a computer, is configured to perform any of the methods disclosed herein.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided. A computer program may, for example, be downloaded (updated) to the existing data processing systems or be stored upon manufacturing of these systems.

Elements and aspects discussed for or in relation with a particular embodiment may be suitably combined with elements and aspects of other embodiments, unless explicitly stated otherwise.

Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 is a schematic drawing of a system comprising a particle manipulation device that can be characterized using the methods disclosed herein;

FIG. 2 shows a particle manipulation device in more detail;

FIG. 2A shows the holding space of a particle manipulation device in more detail;

FIG. 3 shows an exemplary sample holder assembly for the system and method in perspective;

FIG. 4 is a side view of the sample holder 300;

FIG. 5 is a bottom view of the sample holder 300;

FIG. 6 is a perspective cross section view of the sample holder assembly of FIGS. 3-5;

FIG. 7 shows part of the sample holder assembly of FIGS. 3-5;

FIG. 8 is a view like FIG. 7, but partly cut away;

FIG. 9 shows a simplified schematic circuit of an electrical setup of an embodiment of a manipulation system;

FIG. 9A shows a complex phase diagram of the system of FIG. 9;

FIG. 10 is a flow chart illustrating a method according to an embodiment for measuring a temperature of a fluid in a holding space of an acoustic-based particle manipulation device;

FIG. 11 is a flow chart illustrating a illustrating a method according to an embodiment for determining a fluid temperature of fluid in a holding space;

FIG. 12 is a flow chart illustrating a method according to an embodiment wherein several reference temperature value—reference resonance frequency pairs are measured during the calibration;

FIG. 13 is a flow chart illustrating a method for calibrating a temperature sensor of an acoustic-based particle manipulation device according to an embodiment;

FIG. 14 is a flow chart illustrating a method for calibrating a temperature control system of an acoustic-based particle manipulation device according to an embodiment.

FIG. 15 is a flow chart illustrating a method for calibrating a temperature control system and temperature sensor of an acoustic-based particle manipulation device according to an embodiment;

FIG. 16 shows actually measured conductance versus frequency graphs;

FIG. 17 shows simulations of resonance according to an embodiment;

FIG. 18 illustrates a dependence between resonance frequency and fluid temperature;

FIG. 19 illustrates a dependence between temperature sensor output signal and fluid temperature;

FIG. 20 visualizes data that may be stored on a computer-readable storage medium according to an embodiment;

FIG. 21 illustrates a data processing system according to an embodiment.

### DETAILED DESCRIPTION OF THE DRAWINGS

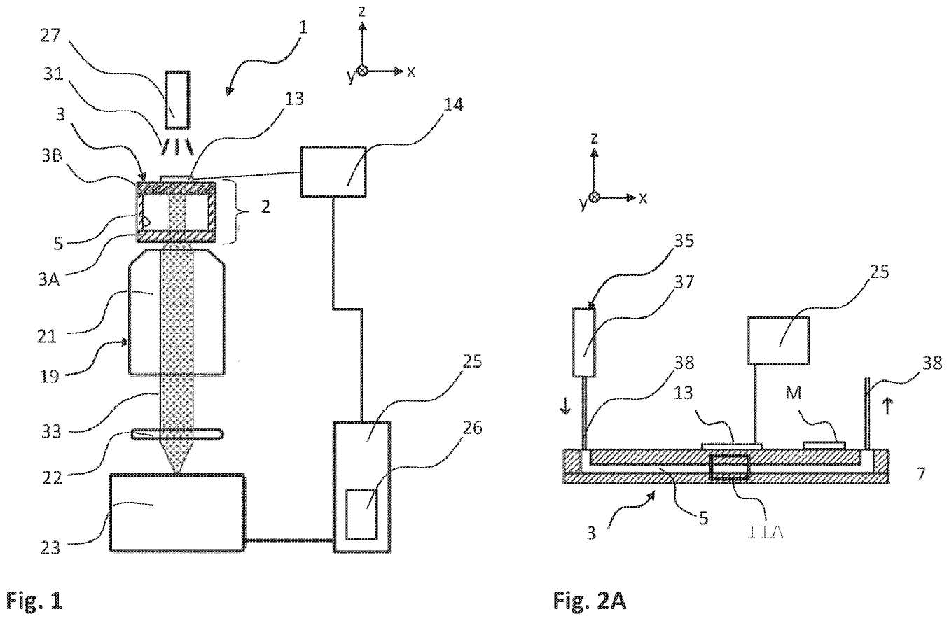

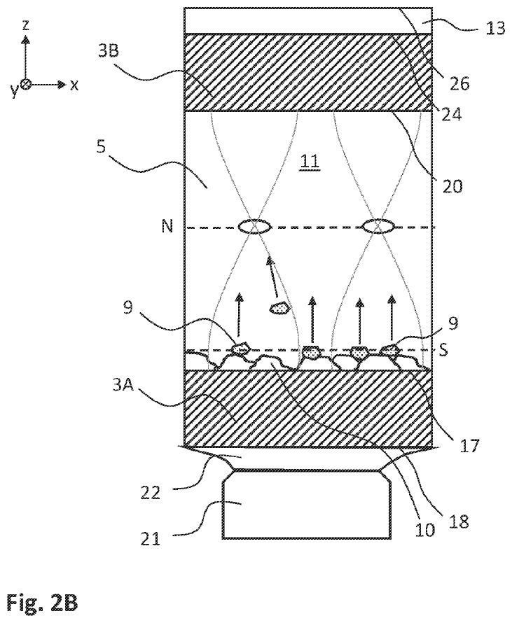

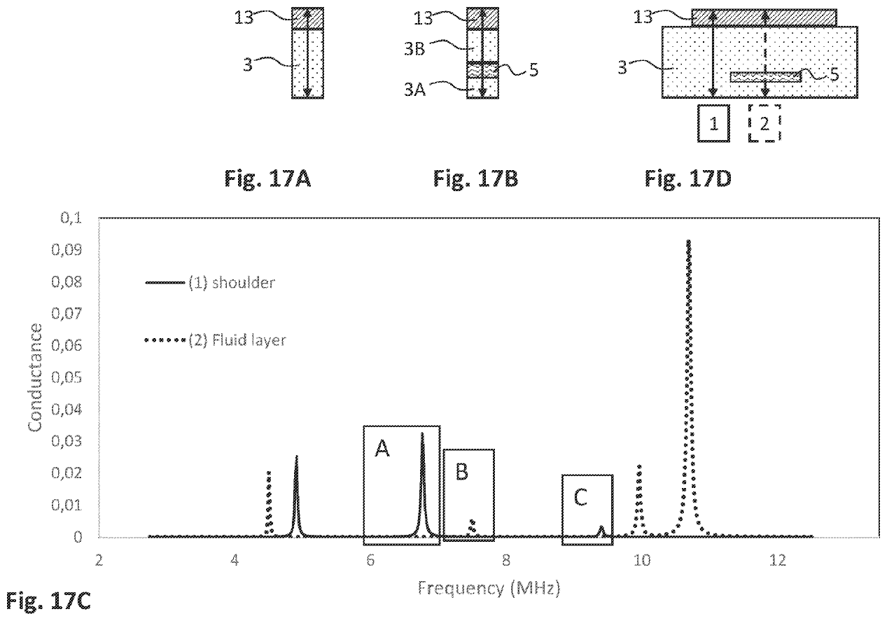

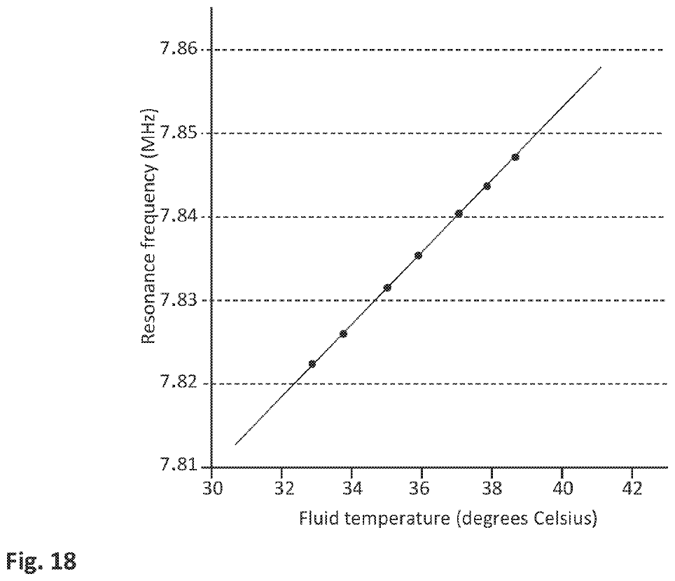

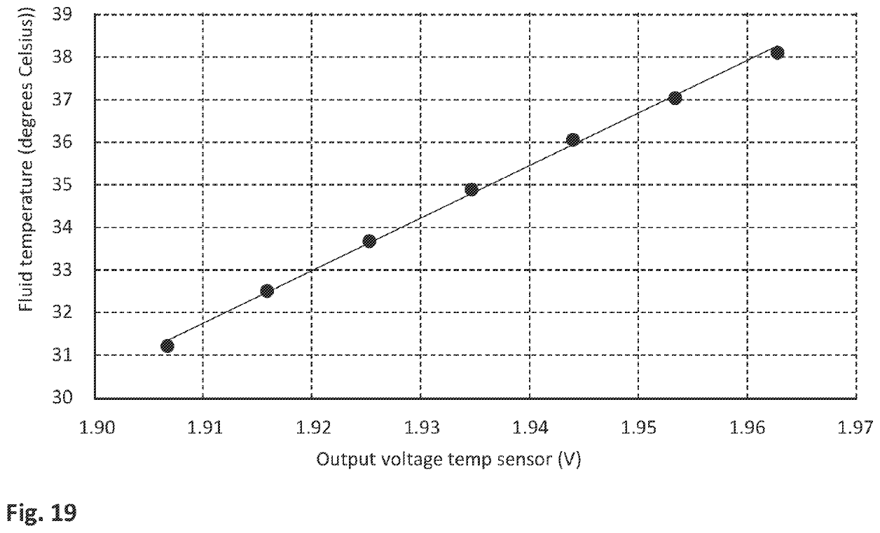

In the figures, identical reference numbers indicate identical or similar elements. However, different reference numbers may very well indicate identical or similar elements. For example, the holding space is indicated by 5 in FIGS. 1, 2 and 2A and by 305 in FIGS. 17 and 18.

FIG. 1 is a schematic drawing of a system 1 comprising an acoustic-based particle manipulation device 2. FIG. 2 is a cross section of a sample holder and FIG. 2A is a detail of the sample holder of FIG. 2 as indicated with “IIA”. How the particle manipulation device 2 can be used to test the adhesion of particles will be explained with reference to FIGS. 1, 2 and 2A.

The particle manipulation device 2 comprises a sample holder 3 comprising a holding space 5 containing a fluid medium 11. The holding space 5 comprises a wall surface portion 17. The holding space 5 is suitable for holding one or more particles of interest, such as one or more biological cellular bodies 9. What is present in the holding space may be collectively referred to as the sample. It is noted that also, or alternatively, other types of particles like microspheres could be used, possibly attached to biological cellular bodies 9. The fluid 11 preferably is a liquid. In response to a driving signal as provided by a signal provisioning system to the sample holder, an acoustic wave is generated in the fluid-medium-containing holding space 5 that is suitable for driving a particle that sits at the wall surface portion 17, away from the wall surface portion 17. The signal provisioning system in the depicted embodiment comprises an acoustic wave generator 13, such as a piezo element, connected with the sample holder 2, and a system 14 comprising a data processing system and power supply (not shown).

During a particle adhesion test, the wall surface portion 17 is typically functionalized in the sense that cellular bodies are present on it and in that particles under investigation adhere to these cellular bodies. The wall surface portion 17 may also or alternatively be functionalized using other specific molecules and/or surface treatments. Typically, the particle manipulation device is used to measure the adhesion forces of particles to a specific surface. This adhesion force may for example be the cellular binding avidity in case both the functionalized layer and the particles are cells but also other interactions may be probed e.g. the surface portion may be functionalized with antibodies, biological materials such as fibronectin or collagen, atomic monolayers such as gold etc. The particles may be cells but they may also be (functionalized) particles such as polymer or glass microspheres, lipid vesicles, or any other particles with sufficient size and acoustic contrast with respect to the medium to allow acoustic manipulation of such particles. A further wall, e.g. opposite wall, may also or alternatively be functionalized in the same way as the wall surface portion 17.

The shown system 1 comprises a microscope 19 with an objective 21 and a camera 23 connected with a computer 25 comprising a controller and a memory 26. The computer 25 may also be programmed for tracking one or more of the cellular bodies based on signals from the camera 23 and/or for performing microscopy calculations and/or for performing analysis associated with (superresolution) microscopy and/or video tracking, which may be sub-pixel video tracking. The computer or another controller (not shown) may be connected with other parts of the system 1 (not shown) for controlling at least part of the microscope 19 and/or another detector (not shown). In particular, the computer 25 may be connected with one or more other parts of the system such as the acoustic wave generator 13, the power supply and/or controller 14 thereof (both as shown in FIG. 1), the light source, a temperature control, sample fluid flow control, etc. (none shown).

The system 1 further comprises a light source 27. The light source 27 may illuminate particles that sit at the wall surface portion 17 using any suitable optics (not shown) to provide a desired illumination intensity and intensity pattern, e.g. plane wave illumination, Köhler illumination, etc., known per se. Here, in the system light 31 emitted from the light source 27 is directed through the acoustic wave generator 13 to the sample holder 3 and sample light 33 from the sample is transmitted through the objective 21 and through an optional tube lens 22 and/or further optics (not shown) to the camera 23. The objective 21 and the camera 23 may be integrated. In an embodiment, two or more optical detection tools, e.g. with different magnifications and/or components related to spectral and/or polarization properties, may be used simultaneously for detection of sample light 33, e.g. using a filter and/or a beam splitter.

In another embodiment, not shown but discussed in detail in WO 2014/200341, the system comprises a partially reflective reflector and light emitted from the light source is directed via the reflector through the objective and through the sample, and light from the sample is reflected back into the objective, passing through the partially reflective reflector and directed into a camera via optional intervening optics. Further embodiments are apparent to the reader.

The sample light 33 may comprise light 31 affected by the particles under investigation (e.g. scattered and/or absorbed) and/or light emitted by one or more portions of the sample itself e.g. by chromophores and/or fluorophores attached to the cellular bodies 9.

Some optical elements in the system 1 may be at least one of partly reflective, dichroic (having a wavelength specific reflectivity, e.g. having a high reflectivity for one wavelength and high transmissivity for another wavelength), polarization selective and otherwise suitable for the shown setup. Further optical elements e.g. lenses, prisms, polarizers, diaphragms, reflectors etc. may be provided, e.g. to configure the system 1 for specific types of microscopy.

The sample holder 3 may be formed by a single piece of material with a channel inside, e.g. glass, injection moulded polymer, etc. (not shown) or by fixing different layers of suitable materials together more or less permanently, e.g. by welding, glass bond, gluing, taping, clamping, etc., such that a holding space 5 is formed in which the fluid 11 contains one or more particles under investigation, at least during the duration of an experiment. As shown in FIGS. 1 and 2, the sample holder 3 may comprise a part 3A that has a recess being, at least locally, U-shaped in cross section and a cover part 3B to cover and close (the recess in) the U-shaped part providing an enclosed holding space 5 in cross section. A monolithic sample holder, at least at the location of the acoustic wave generator 13, may be preferred over an assembled sample holder for improving acoustic coupling, reducing losses and/or preventing local variations.

As shown in FIG. 2, the sample holder 3 is connected to an optional fluid flow system 35 for introducing fluid into the holding space 5 of the sample holder 3 and/or removing fluid from the holding space 5, e.g. for flowing fluid through the holding space (see arrows in FIG. 2). The fluid flow system 35 may comprise a manipulation and/or control system, possibly associated with the computer 25. The fluid flow system 35 may comprise one or more of reservoirs 37, pumps, valves, and conduits 38 for introducing and/or removing one or more fluids, sequentially and/or simultaneously. The sample holder 3 and the fluid flow system 35 may comprise connectors, which may be arranged on any suitable location on the sample holder 3, for coupling/decoupling without damaging at least one of the parts 3, 35, and preferable for repeated coupling/decoupling such that one or both parts 3, 35 may be reusable thereafter. Further, an optional machine-readable mark M or other identifier is attached to the sample holder 3. Further, a computer-readable storage may be attached onto the sample holder (not shown). Such sample holder may have stored information obtained during calibration methods described herein, such as the measured reference temperature values in association with the respective measured reference resonance frequencies.

FIG. 2A is a schematic of a number of particles 9, such as cellular bodies, in the sample holder 3 of FIG. 2. At least part of the wall surface portion 17 of the sample holder 3 is functionalized in the sense that e.g. it is covered with biological cells 10 preferably of a different type to which the particles of interest 9 may adhere. Also shown is part of the microscope lens 21 and an optional immersion fluid layer 22 for improving image quality. It may be preferred not to use an immersion fluid in order to prevent acoustic coupling of the sample holder to the microscope objective.

On providing an, optionally periodic, driving signal to the sample holder, e.g. by providing a control signal to acoustic wave generator 13, an acoustic wave, e.g. an acoustic standing wave, is generated in the holding space 5. The signal may be selected, as indicated, such that an antinode of the wave is generated at or close to the wall surface 17 (of the sample holder 3) and a node N of the wave W away from the wall surface 17, generating a local maximum force F on the particles 9 at and/or near the wall surface 17 towards the node. Thus, application of the driving signal may serve to probe adhesion of the particles 9 to the surface 17 and/or to any functionalised layer on it in dependence of the force. The driving signal can namely cause the particles 9 that are present at the wall surface portion 17 and optionally adhered to a functionalized layer on the wall surface portion, to experience an acoustic force of certain magnitude that drives the particles away from the wall surface portion, namely towards one of the nodes N. Based on, for example, the images as obtained by camera 23, it can be determined when particles detach from such functionalized layer on the wall surface 17. The moment of detachment of a particle can be linked to the acoustic force that the particle experienced at that moment. During an experiment it is, of course, accurately monitored which driving signal is applied to the sample holder at which time and/or which acoustic force the particles experience at which time. In this way, the adhesion of particles can be tested.

In an example an optimal force generation for particular studies may be achieved by selecting acoustic cavity parameters and the frequency/wavelength of the acoustic wave in order to create a maximum pressure gradient at the wall surface portion 17, e.g. by ensuring that the distance from the wall surface to the acoustic node is approximately ¼ wavelength.

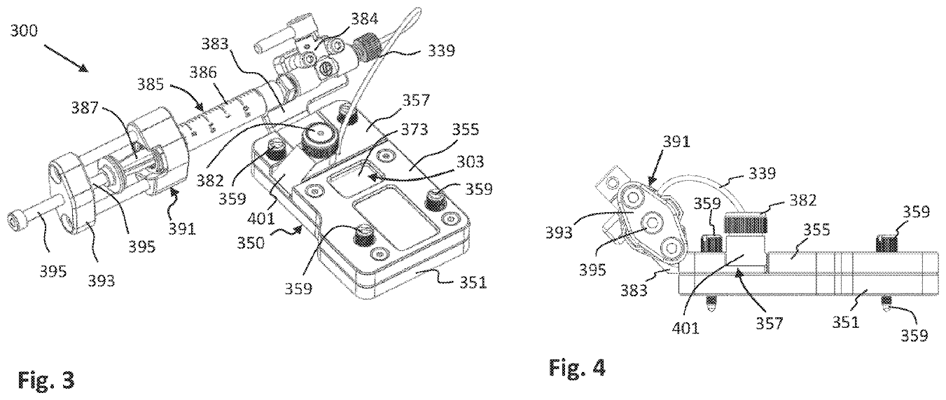

FIG. 3 shows an exemplary sample holder 300 for the system and method in perspective.

FIG. 4 is a side view of the sample holder 300.

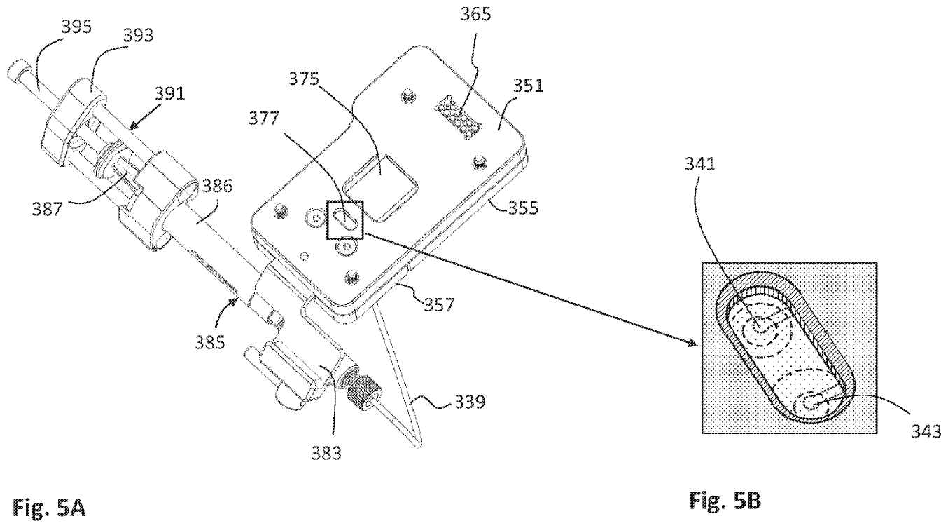

FIG. 5 is a bottom view of the sample holder 300.

The sample holder 300 comprises a “chip” 303 in a housing 350. FIG. 5A is a detail of FIG. 5.

The shown housing 350 comprises a bottom shell 351 and an upper shell 353, which here comprises two parts, referred to as chip cover 355, and connector part 357, respectively. The housing 350 holds the chip 303.

The parts 351, 353 (=355, 357) are attached together around the chip 303, e.g. using bolts 358 as indicated, but other attachment systems could be used, e.g. clamps, and/or be permanently attached, e.g. glued or welded. It is noted that a suitable housing could comprise more or less parts and each part and/or the housing as a whole could be shaped differently than shown here. The housing 350 may be at least partly opaque. Screw bolts 359 are provided as one option for fixing the sample holder 300 to other parts of the system (not shown).

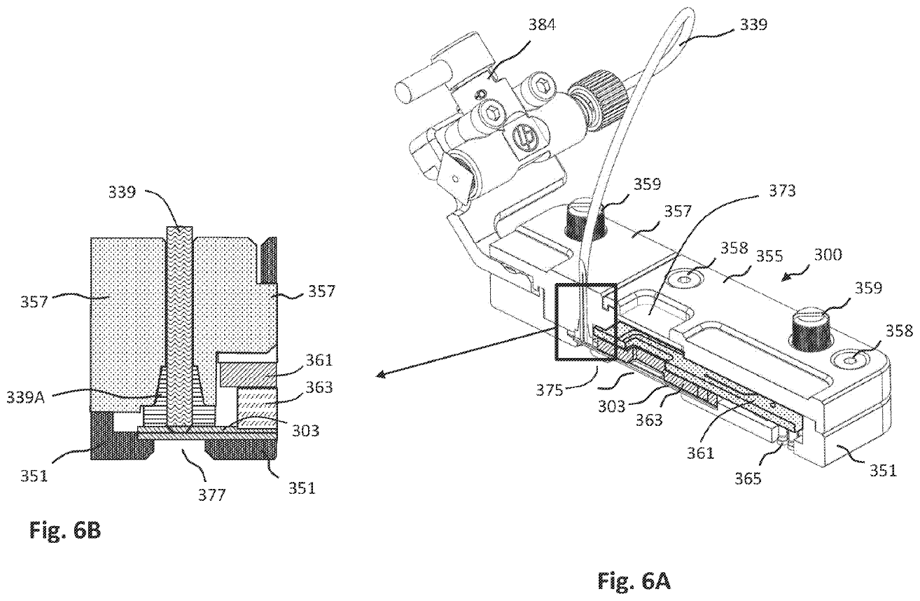

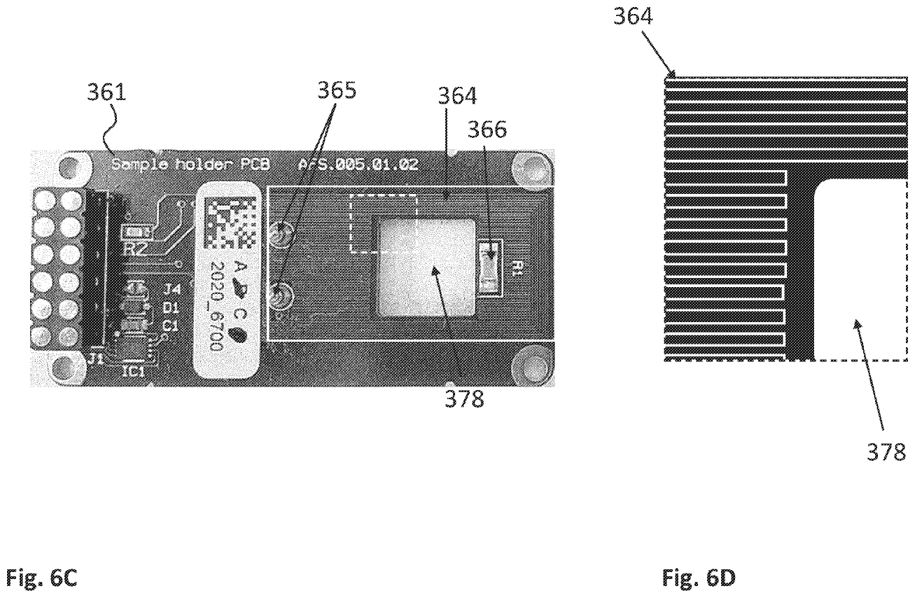

FIG. 6 is a perspective cross section view of the sample holder assembly of FIGS. 3-5, showing the sample holder or “chip” 303 in the housing 350. Also visible is that the housing 350 further accommodates an optional printed circuit board 361 (“PCB”) and an optional connector pad 363. The PCB 361 may provide any electrical connection to the chip and/or may provide other functions such as chip ID, calibration parameters and temperature control. The connector pad 363 may facilitate a thermal connection between the chip and the PCB 361. Preferably, the PCB 361 comprises a temperature control system, for example in the form of so-called PCB heater structures. Such PCB heater structures are typically one or more conductive traces that are configured to generate heat when a suitable voltage is applied across them. Such one or more conductive traces for example essentially consist of high resistance material. The generated heat heats the surrounding materials. The optional connector pad 363 may function to transfer the heat generated by the PCB heater structures to the fluid in the holding space 305 (see below) in order to heat up the fluid in the holding space to a desired temperature.

In an example, the total surface area on the PCB accommodating such one or more conductive traces is 2 cm². The conductive trace may have a resistance of 10 Ohm approximately, and may be supplied with a voltage, e.g. ranging from 10 V-20V. The amount of generated heat may be controlled by adapting a duty cycle of the provided voltage. To illustrate, for heating the fluid in the holding space 305 to 37 degrees Celsius, 17 Watt may be applied across the heat trace to with a duty cycle of 16% (which is effectively 2.72 Watt).

A multi-pin electrical connector 365 is provided for connecting control- and/or power signals to an optional acoustic transducer on the chip 303, (see also FIG. 5) and/or for other signals for one or more of control, power, temperature control, detection and measurement.

FIG. 6B is a photograph of a PCB 361 according to an embodiment. Indicated are the connectors 365 for the electrodes 380 of the transducer, a gap 378 in the PCB configured to provide optical access to the holding space, a temperature sensor 366 according to an embodiment, and a temperature control system 364, which in this embodiment is formed by one or more heater structures, e.g. in the form of conductive heat traces on the PCB in the solid line box as shown. FIG. 6C shows the dashed box in FIG. 6B enlarged. Here, the conductive traces 364 are clearly visible as white lines. As said, typically, the holding space sits underneath the gap 378 and the window 373. FIGS. 6B and 6C clarify that the temperature control system 364 may be configured to only heat material of the sample holder surrounding the holding space. It typically cannot directly heat the fluid inside the holding space.

FIGS. 3, 5 and 6 show that the chip cover 355 comprises a first window 373 and that the bottom shell 351 of the housing 350 comprises two windows 375 and 377, respectively. The windows 373, 375 are arranged overlapping, possibly registered, and allow approaching of and/or contact and/or optical access to the chip 303 (see also below) as well as allowing that the housing 350 is opaque elsewhere. However, in the shown embodiment, the connector part 357 is transparent. The windows 373, 375, 377 are optional and if present may be formed as openings, as here, and/or one or more of them may comprise a transparent portion.

FIG. 5A is a detail of FIG. 5, as indicated, and shows that the window 377 provides optical access to and/or illumination of part of the chip 303, in particular the inlet 341 and outlet 343 of a channel 304 in the chip 303, see below.

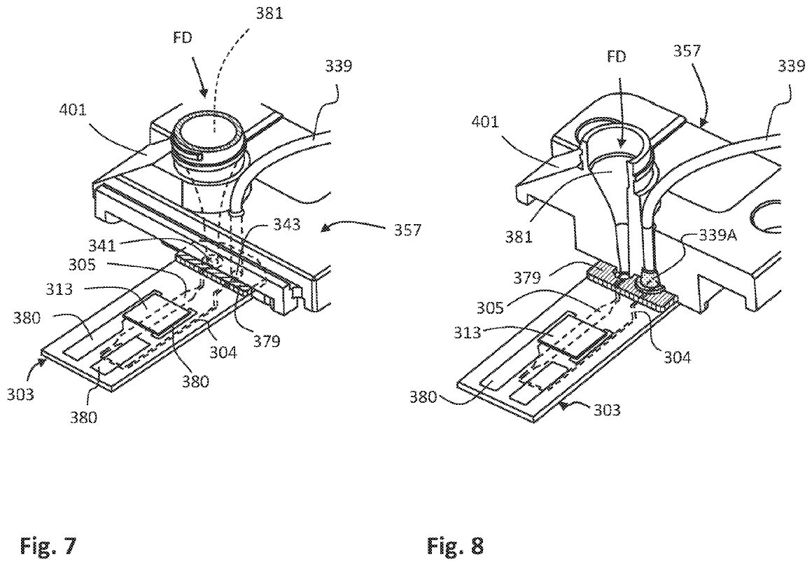

FIG. 7 shows the connector part 357 of the housing 350 and the chip 303, without the bottom shell 351 and chip cover 355. Between the connector part 357 and the chip 303 a resilient sealing gasket 379 is arranged, providing a liquid and gas tight connection between the connector part 357 and the chip 303. In dashed lines, some (not all) structures are indicated which are internal in the connector part 355, the gasket 379 and the sample holder 303, respectively.

FIG. 8 is a view like FIG. 7, but now with part of the connector part 357 cut away.

In the chip 303 a fluid channel 304 is indicated. The chip 303 may be, as shown, generally planar and the channel 304 is generally U-shaped in such plane. The channel 304 comprises a widened portion 305 which forms a holding space (similar to holding space 5 of FIGS. 1, 2 and 2A) for a sample for experiments. The (channel 304 of) chip 303 comprises an inlet 341 and an outlet 343 for fluid sample materials. The sample holder 303 further is provided with an acoustic wave generator 313 such as a piezo element or other transducer for generating an acoustic wave in the holding space 305 (similar to the transducer 13 of FIGS. 1, 2 and 2A). FIGS. 7 and 8 also show electrical connections 380 for the acoustic wave generator 313.

The connector part 357 comprises a sample liquid reservoir 381 fluidly connected with the inlet 341 of (the channel 304 of) the chip 303. The liquid reservoir 381 is closeable gas tight with a sealed cap closure 382 (see also FIGS. 3, 4). Further, the connector part 357 provides a conduit 339 fluidly connected with the outlet 343 of (the channel 304 of) the chip 303, here via an optional ferrule 339A contained in or by the gasket 379, providing a liquid and gas tight seal (see also FIG. 6A).

Referring again to FIGS. 3-6, attached to the housing 350 is an optional mount 383 holding a valve 384. The valve 384 is connected with the chip 303 via the conduit 339.

A syringe 385, or other fluid reservoir, may be connected with the valve 384 as shown, preferably releasably connected. The syringe 385 comprises a cylinder 386 and a piston 387. In the shown embodiment, the syringe 385 is provided with an optional adjustable clamp 391. The clamp 391 and the syringe 385 are attached to each other, preferably removably attached. The shown exemplary clamp 391 comprises a mount 393 and a pusher 395 threaded into the mount 393. When the clamp 391 and the syringe 385 are operably assembled as shown, the clamp 391 can controllably depress the piston 387 into the cylinder 386 of the syringe 385 by screwing the pusher 395 into or out of the mount 393. Likewise, also or alternatively a desired relative position of the piston 387 and the cylinder 386 may be established and maintained. The assembly of the syringe 385 and the clamp 391 serves as an adjustable compressor as will be set out below.

The connector part 357 provides a window 401 for optical detection, in particular visual detection, of a liquid level and/or a level mark in the reservoir 381. The window 401 also allows the user or the system to detect potential bubble issues, in particular by allowing inspection close to the bottom of the reservoir and/or the inlet hole 341 of the chip. For that, at least part of the connector part 357 is transparent, possibly all of the connector part 357, as in the shown embodiment. Preferably most of the reservoir 381 if not all of it is visible through the window 401. The window 401 may be plane or be curved or otherwise formed to provide lens action for magnification and/or otherwise facilitating detecting a liquid level in the reservoir. The orientation of the window 401 and/or further more or less conspicuous optical indicators may urge a user to adopt a predetermined viewing angle and/or direction, thus increasing consistency between detections and reliability of the procedure.

Due to the translucency and/or transparency of the connector part 357 level indication is facilitated, which may be further assisted by the window 377 enabling access of light “from below”.

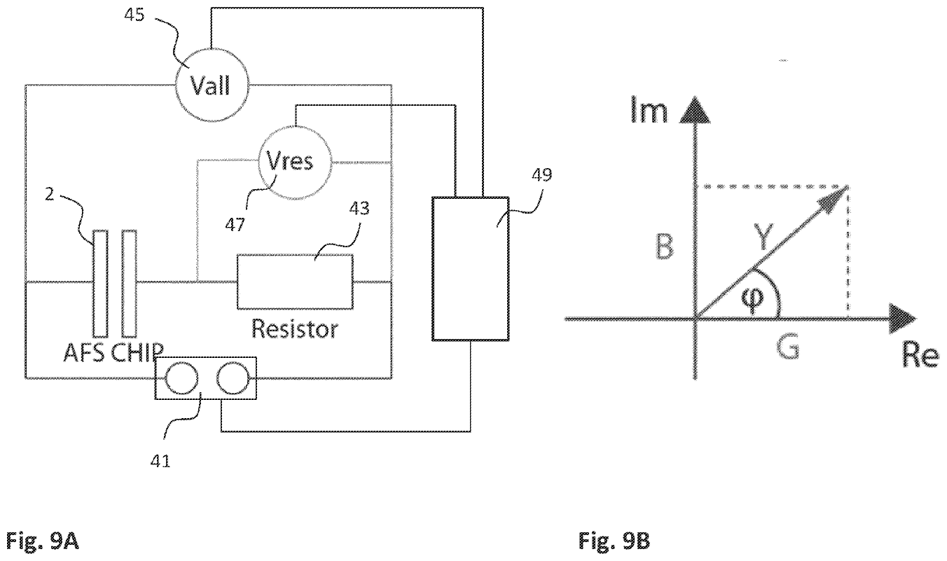

FIG. 9 shows a simplified schematic circuit of an electrical setup of the system 1. Here, the particle manipulation device 2 including sample holder 3 and acoustic wave generator 13 are considered together as a functional unit AFS Chip indicated at 2, having an impedance Z. A power supply 41 is provided for generating a periodic driving signal, having a signal frequency, a signal amplitude and a signal power. The power supply 41 is connected to the particle manipulation device 2, which may be referred to as a chip, in series with a reference resistor 43. Voltage measurement devices 45, 47 for measuring Vall and Vres are provided as indicated. The power supply 41 and voltage measurement devices 45, 47 are connected to a controller 49, which may comprise an analog-to-digital converter (ADC) and/or which may be connected with, or be part of, the controller 14 and/or the computer 25. Vchip, the voltage across the acoustic wave generator, can then also be calculated as Vchip=Vall−Vres.

When providing an oscillating driving voltage Vin by the power supply 41 to the particle manipulation device 2, a phase difference φ between Vall and Vres will occur, which may be measurable. The following values may be determined (see also the complex phase diagram in FIG. 9A):

Impedance: |Z|=(Vchip)Rres/Vres

Admittance: |Y|=1/|Z|
wherein

Complex admittance: Y=|Y| exp(−jφ)=G+jB

Susceptance: B=|Y|sin(−φ)

Conductance: G=|Y|cos(φ)

The particle manipulation device 2 has certain resonance frequencies. At each resonance frequency, the conductance is at a maximum.

The acoustic-based particle manipulation devices described herein may also be referred to a as acoustic-based particle adhesion test devices and may be understood to be acoustic and/or microfluidic chips. As explained these devices can be used to apply a force to particles that are present on an, optionally functionalized, wall surface portion. This allows for interesting experiments. For example, by applying forces to immune cells bound to a layer of tumor cells on the wall surface portion and by simultaneously imaging the cells and determining unbinding events one can characterize the binding force of the immune cells on the tumor cells. This binding force, or binding avidity, is an essential parameter in the process of immune recognition. In another example molecules, such as for example DNA molecules, may be bound to the wall surface portion and beads, e.g. 10 um polystyrene beads, may be attached to the other end of the DNA molecules. Acoustic forces may be used to push the beads away from the wall surface portion and stretch the DNA molecules. By measuring the height of the beads above the surface, e.g. by using video microscopy, one may determine mechanical signatures of the molecules and/or changes in these mechanical signatures induced by e.g. other molecules such as proteins that bind to the molecules.

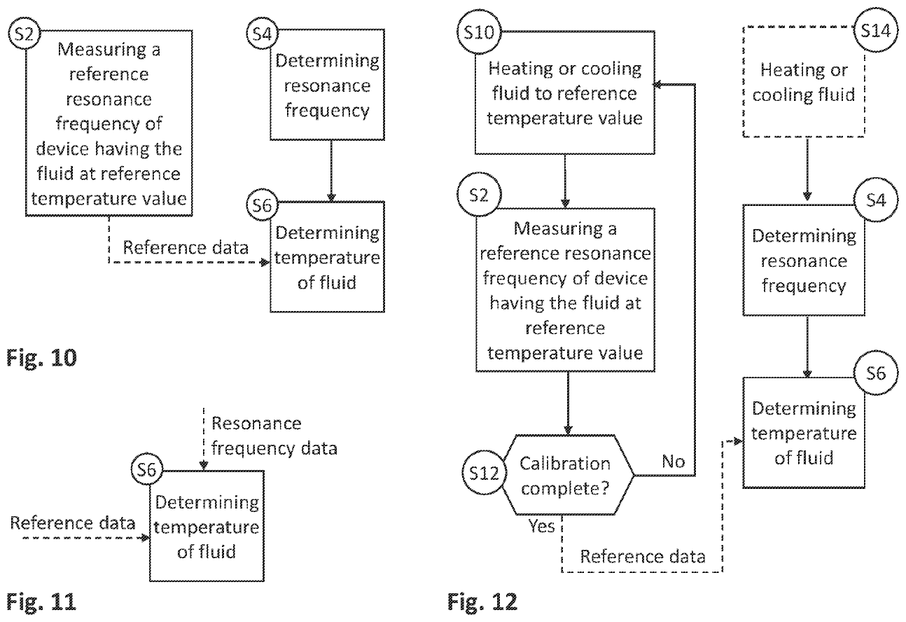

FIG. 10 is a flow chart illustrating a method according to an embodiment for measuring a temperature of a fluid in a holding space of an acoustic-based particle manipulation device. This embodiment comprises a step S2 of performing a calibration comprising measuring, using a reference temperature sensor, the temperature of the fluid to be a reference temperature value, and determining a reference resonance frequency of the acoustic-based particle manipulation device having the fluid in its holding space at the reference temperature value. The output of this step may be so-called reference data that associate the reference temperature value with the reference resonance frequency. This reference data may then be used in step S6 (see below).

Step S4 may be performed independently from step S2. Steps S2 and S4 are preferably performed one after the other. Step S4 may be performed before step S2. However, preferably, step S2 is performed before step S4. Step S2 may be performed as a last step in the production process of the acoustic-based particle manipulation device. In any case, step S4 comprises measuring the temperature of the fluid comprising determining a resonance frequency of the acoustic-based particle manipulation device.

Once steps S2 and S4 have been performed, step S6 may be performed, which comprises determining, based on the reference resonance frequency determined during the calibration and based on the determined resonance frequency, the temperature of the fluid to be a temperature value.

FIG. 11 illustrates an, optionally computer-implemented, method according to an embodiment. A data processing system for example receives reference data as output from a calibration experiment, e.g. step S2, and resonance frequency data as measured during a step S4. Thus, such embodiment comprises obtaining reference data, the reference data indicating for an acoustic-based particle manipulation device comprising a holding space containing a fluid, for one or more reference temperatures of the fluid one or more respective reference resonance frequencies, and obtaining measurement data, the measurement data indicating one or more measured resonance frequencies of the acoustic-based particle manipulation device. Bases on these data, step S6 may be performed which comprises determining, based on the reference data, for each of the one or more measured resonance frequencies indicated by the measurement data, a respective temperature of the fluid.

FIG. 12 is a flow chart illustrating yet another embodiment. Herein, multiple measurements are performed during calibration, i.e. multiple reference temperature value—reference resonance frequency pairs are obtained. It should be appreciated that step S2 may be performed as a first step in this embodiment. In such case, no heating or cooling is performed for the first reference measurements. However, step S10 may also be performed, i.e. the calibration may start at some desired temperature.

In any case, after step S2 has been performed, as explained with reference to FIG. 10, a step S12 is performed. In step S12, it is decided whether sufficient reference measurements have been performed. If not, then step S10 is performed which comprises heating or cooling the fluid to another reference temperature value. Step S10 may be performed by keeping an environment at some reference temperature value and inserting the acoustic-based particle manipulation device in said environment, such as an oven and/or incubator, so that the temperature of the fluid after some time period has the reference temperature value. In one embodiment, one may set an oven to some reference temperature, insert the device in the over and wait for some time period long enough that the device reaches an equilibrium state in which the entire device, including the fluid is at the targeted reference temperature value. In such case, the temperature of the fluid is measured to be the reference temperature value by measuring the temperature of the environment, e.g. of the oven, in which the device has been inserted.

Then, step S2 is performed again which comprises measuring, using the reference temperature sensor, the temperature of the fluid to be this other reference temperature value and determining a further reference resonance frequency of the acoustic-based particle manipulation device having the fluid in its holding space at this other reference temperature value. It should be appreciated that, in principle, every time step S10 is performed, the fluid is heated or cooled to another reference temperature value. This allows to obtain reference resonance frequencies for a large range of fluid temperatures. After the calibration has been finished, again, reference data may be input into step S6, explained already with reference to FIG. 10.

Steps S4 and S6 have already been explained with reference to FIG. 10. However, it should be appreciated that the determination of step S6 in the embodiment of FIG. 12 is performed preferably based on multiple reference resonance frequencies measured during the calibration.

As indicated by optional step S14, optionally, the fluid is deliberately heated prior to some temperature value before measuring the resonance frequency, e.g. using a temperature control system as described herein. This would typically happen during actual experiments.

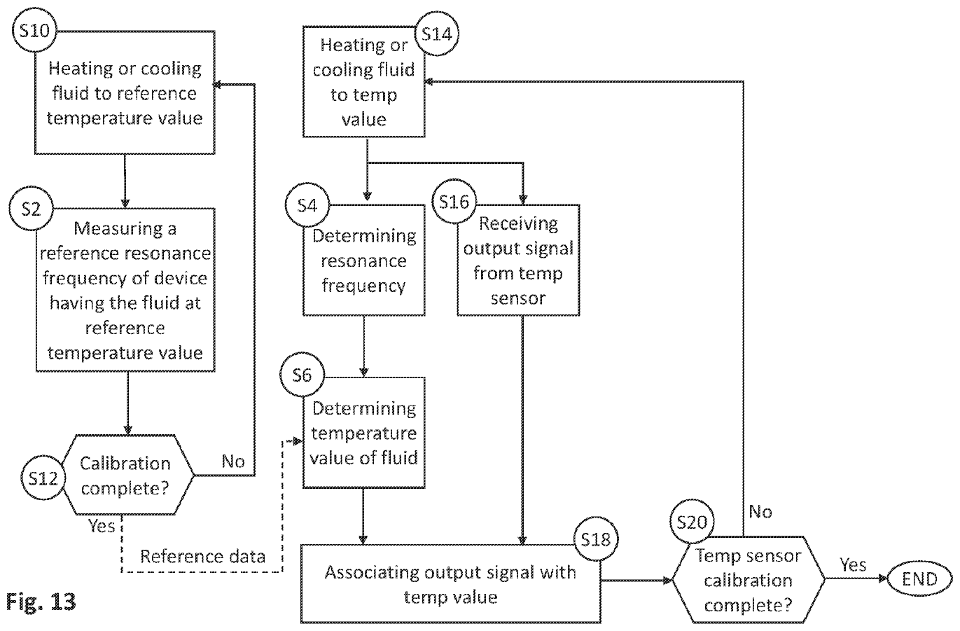

FIG. 13 is a flow chart illustrates a method according to an embodiment, wherein the acoustic-based particle manipulation device comprises a temperature sensor for measuring the temperature at a position outside of the holding space, preferably said position being in or on the acoustic-based particle manipulation device. Steps S10, S2, S12, S14, S4, S6 have been described above.

Step S16 comprises receiving an output signal from the temperature sensor indicative of the temperature at said position when said step of determining the resonance frequency of the acoustic-based particle manipulation device is performed. This allows to, as indicated in step S18, associate the output signal with the temperature value determined in step S6. The temperature sensor for example outputs a voltage that is indicative of the temperature that it measures at the position outside the holding space. Associating the output signal with determined temperature may thus be performed by associating the output voltage with the determined temperature value of the fluid.

Preferably, of course, the temperature sensor is calibrated for various temperatures as indicated by step S20. In step S20 it is decided whether the calibration of the temperature sensor is finished or not. If so, then the method ENDS, if not, then step S14 is performed again.

It should be appreciated that an embodiment according to FIG. 13 is especially useful if the temperature control system that is used in step S14 only locally heats the particle manipulation device in the sense that it creates a temperature gradient in the device. In such case, the methods described herein allow to, despite such temperature gradients, which may be relatively strong, accurately determine the temperature of the fluid. In such case, being able to accurately measure the temperature of the fluid using a temperature sensor that is configured to measure the temperature at a position outside of the holding space is highly convenient.

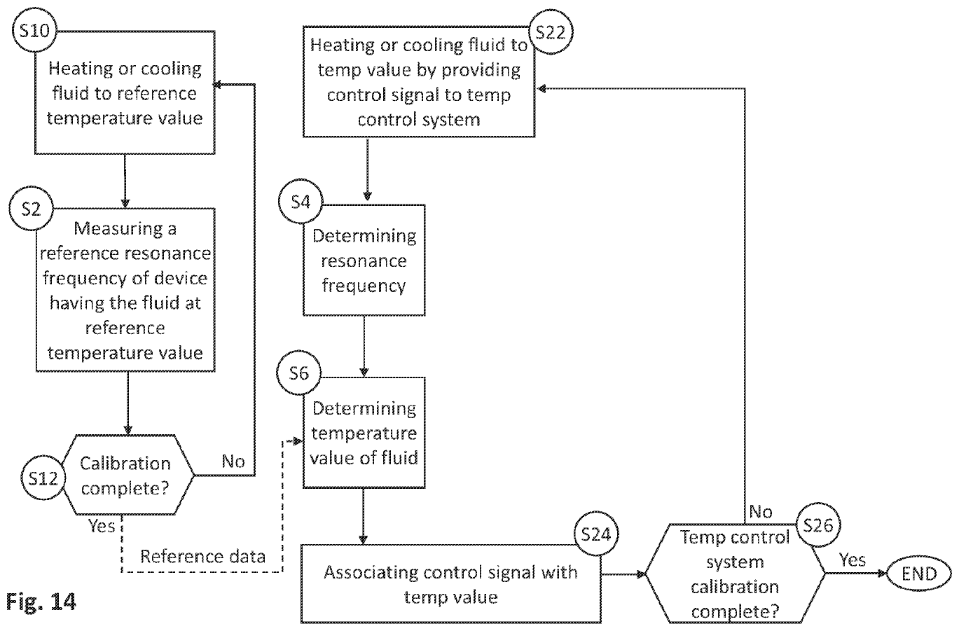

FIG. 14 is a flow chart illustrates a method according to an embodiment, wherein the acoustic-based particle manipulation device comprises a temperature control system for heating and/or cooling the fluid in the holding space. Steps S10, S2, S12, S4, S6 have been described above. Further, step S22 is the same as step S14 with the additional specification that the fluid is heated or cooled using a temperature control system by providing a control signal to the temperature control system.

This allows to, in step S24, associating the control signal with the temperature value. In step 26 it is decided whether the calibration of the temperature control system is complete or not. If so, then the method ends, if not, then steps S22, S4, S6 are performed again.

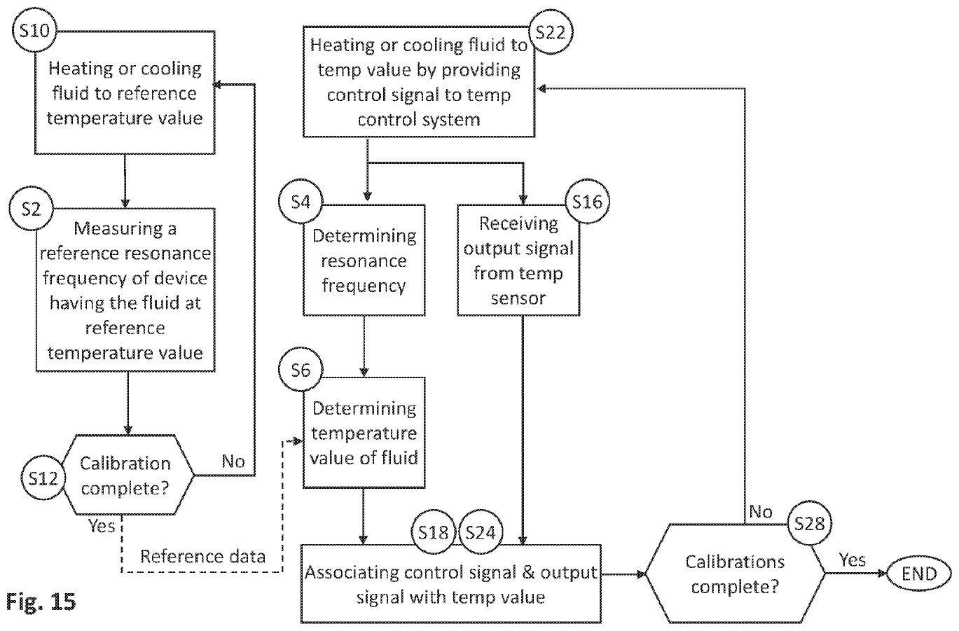

FIG. 15 illustrates an embodiment, wherein during each iteration, the temperature value is associated both with the control signal provided to the temperature control system and with the output signal of the temperature sensor.

It should be appreciated that associating any signal, be it a control signal provided to a temperature control system or an output signal as output by a temperature sensor, with a temperature value may be embodied as storing on a computer-readable storage medium an indication of a value of such signal, such as the signal's voltage and/or current and/or electrical power, in association with an indication of the temperature value.

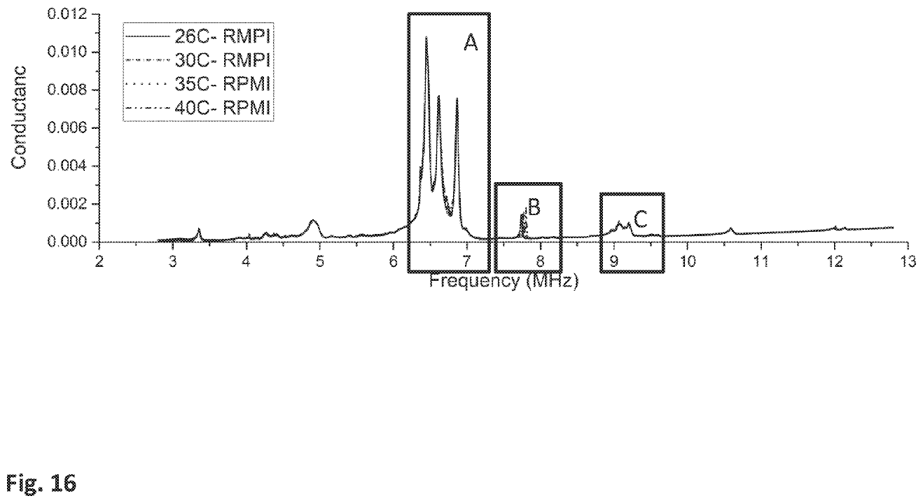

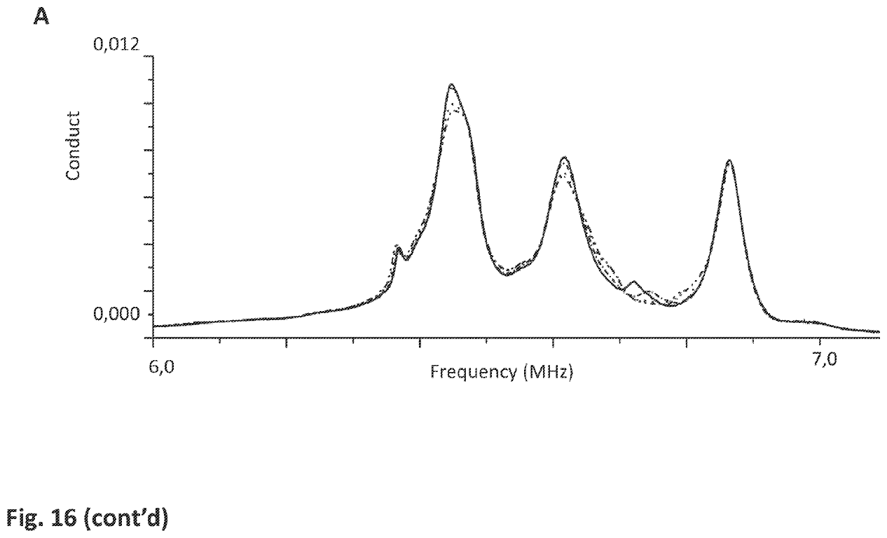

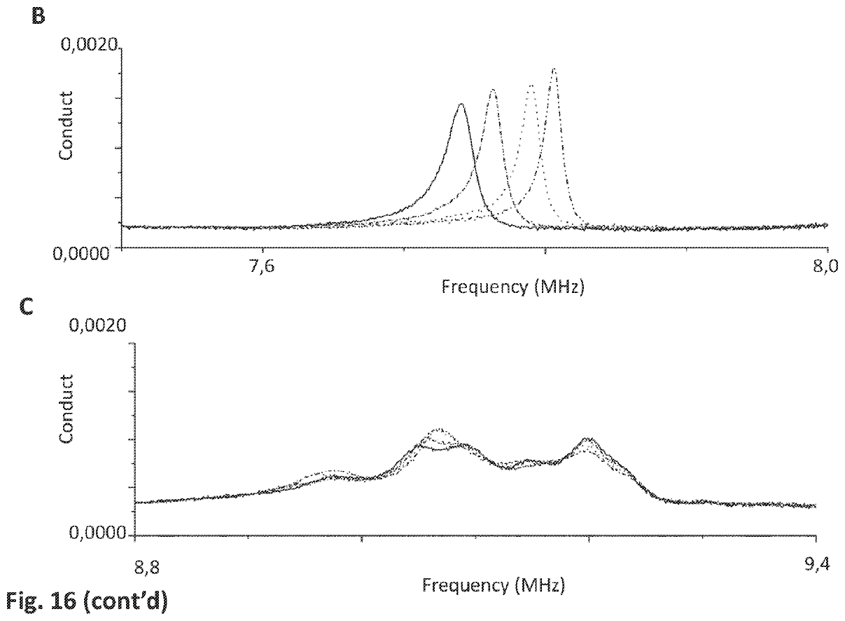

FIG. 16 shows a conductance versus frequency graph. The frequency is the frequency of an oscillating driving signal that is provided to the holding space of an acoustic-based particle manipulation device. Such driving signal may be provided by means of a transducer that is configured to convert an electrical signal into mechanical vibrations, wherein the driving signal may be provided to the transducer.

Three section A, B and C are indicated in the top graph, which sections are shown enlarged on the bottom in, respectively, graphs A, B and C.

The conductance versus frequency graph may be obtained as explained with reference to FIG. 9. The frequency of the driving signal is varied and, for each frequency, the conductance may be determined. The frequencies at which conductance peaks occur, are resonant frequencies of the acoustic-based particle manipulation device. As such, the resonance frequencies and reference resonance frequencies referred to in this disclosure can be determined. At which frequencies the device resonates depends on the specific mechanical properties of the oscillator, e.g. of the transducer that produces the mechanical vibration, the sample holder and the fluid medium.

Preferably, a power of the driving signal is kept relatively low while varying the frequency of the driving signal in order to prevent heat caused by the driving signal from heating the fluid and herewith substantially distorting the calibration.

The resonance quality factor, also referred to as quality number or Q-factor, provides an indication of system- and frequency characteristics and an indication of efficiency of exciting the acoustic wave at and/or near the resonance frequency and/or using such acoustic wave. Therewith, the Q-factor provides additional information about behavior of the system and efficiency of manipulating a portion of a sample in the holding space.

Thus, a frequency sweep may be performed to find the frequencies at which the acoustic-based particle manipulation device resonates. Such resonance frequencies may be found by monitoring the conductance, which will be explained in more detail below.

The top graph actually contains data of four frequency sweeps that have been respectively performed at four different temperatures as indicated by the legend, namely 26 degrees Celsius, 30 degrees Celsius, 35 degrees Celsius and 40 degrees Celsius. For these four frequency sweeps, the temperature was controlled by inserting the entire particle manipulation device into an oven that was kept at a specific temperature, waiting until the device reached a thermal equilibrium and performing the frequency sweep. These steps were repeated for all four temperatures. The fluid in the holding space in this case was a cell culture medium referred to as RPMI.

The inventors have found that only the peaks that are found in section B show a dependence on temperature, whereas for example the peaks in sections A and C do not. The higher the temperature, the higher the resonant frequency in section B. This shift is clearly visible in graph B. On the other hand, the peaks in graphs A and C do not show such temperature driven shift.

Further, it is known that the peaks in section B are associated with the fluid in the sense that the peaks in section B disappear if a frequency sweep is performed on the particle manipulation device without having fluid in its holding space. This is not true for the peaks in sections A and C for example, which remain even if the device does not contain any fluid in its holding space.

In light of this, it can safely be assumed that the shift that is visible in section B is caused by a temperature shift of the fluid itself, and not, at least to a lesser extent, by a temperature shift of the material, e.g. glass, surrounding the holding space. After all, the resonance peaks that are associated with the material forming the holding space, e.g. glass, remain at the same frequencies when the temperature is varied. Thus, the mechanical properties relevant for the resonant characteristics of this material are not strongly temperature-dependent.

That the shift of the resonance frequencies in section B is caused only by the temperature shift of the fluid itself is important, because it allows to accurately determine the temperature of the fluid without having to know the temperature of material near and/or surrounding the holding space. This becomes especially relevant if local heating is employed for heating the fluid inside the holding space. Local heating namely typically causes a temperature gradient between the local heater structure and fluid, meaning that the material near and/or surrounding the holding space has a different temperature than the fluid inside the holding space. The material that sits between a local heater structure and the holding space would typically have a higher temperature than the fluid inside the holding space. On the other hand, the material that sits at an opposite side of the holding space, i.e. that sits remote from such local heater structure, would typically have a lower temperature than the fluid in the holding space.

In light of the above, it is understood that for the temperature measurements disclosed herein, the resonance frequencies in section B are of interest. A frequency sweep that is performed for finding the (reference) resonance frequencies referred to herein for determining a temperature may for example be performed in the range 7.5 to 8.0 MHz. The voltage used for such sweep is for example 0.8 Vpp=0.283 Vrms. The impedance may then be approximately ˜350 Ohm meaning that the power is Vrms²/impedance=0.22 milliwatt.

Graph 17C shows the outcomes of two simulations. In each simulation a (virtual) frequency sweep was performed on a respective (virtual) device. The solid line (1) indicates the conductance versus frequency for the virtual device shown in FIG. 17A and the dotted line (2) indicates the conductance versus frequency for the virtual device shown in FIG. 17B. The model that was employed here was a one-dimensional model, which is why the virtual devices are defined only in one dimension (along the double arrow). The dimension of these devices is the same as the device that was actually tested for FIG. 16, i.e. 0.8 mm in height. The virtual device of FIG. 17A only contains transducer 13 and sample holder 3, which in this example essentially consisted of glass, whereas the device of FIG. 17B comprises a holding space 5 containing a fluid medium.

The solid line of graph 17C exhibits peaks in sections A and C, which correspond to sections A and C of FIG. 16. Further, the dotted line exhibits a peak in section B, which corresponds to section B of FIG. 16.

In light of the above, it is clear that the peak in section B of FIG. 16 is associated with resonances of a subsystem of which the fluid is part. Such resonances, which may be referred to herein as channel resonances, are schematically illustrated in FIG. 17D by the dotted double arrow 2. On the other hand, the resonances in sections A and C of FIG. 16 are of a subsystem of which the fluid is not part. Such resonances, which may be referred to herein as shoulder resonances, are schematically illustrated in FIG. 17D by the solid double arrow 1.

In an embodiment, the method comprises determining the temperature of the fluid to be the temperature value comprises determining a dependence between fluid temperature and resonance frequency of the acoustic-based particle manipulation device based on the reference resonance frequency and the second reference resonance frequency. Based on the determined resonance frequency and based on such dependence, the temperature of the fluid can be determined.

Graph 18 shows as dots the measured reference frequency—reference temperature value pairs. Based on these dots a dependence can be determined as indicated by the solid line. In this example, the dependence is:

Resonance frequency=0.00443 T+7.6808, wherein T is in degrees Celsius and the resonance frequency in MHz.

Such dependence allows to calculate for any measured resonance frequency, e.g. measured during an actual experiment, the temperature of the fluid.

Graph 19 shows as dots the measured fluid temperature using methods described herein and their associated voltage output as output by a temperature sensor that is configured to measure the temperature at a position outside the holding space. The solid line indicates a dependence that is determined based on these points. In this example the dependence is: Fluid Temperature=122.69*Output voltage−202.56. Such dependence allows to determine the fluid temperature based on any voltage as output by the temperature sensor.

Thus, in an embodiment, the method comprises, based on multiple output signal—fluid temperature value pairs, wherein the output signal is output by a temperature sensor that is configured to measure the temperature at a position outside of the holding space, determining a dependence between output signal and fluid temperature. In such embodiment, the fluid temperature may be determined based on a measured resonance frequency and the determined dependence. In an embodiment, the method comprises storing such determined dependence on a computer-readable storage medium, which may be present on or in the acoustic-based particle manipulation device.

Likewise, in an embodiment, the method comprises based on multiple control signal—fluid temperature value pairs, wherein the control signal is provided to a temperature control system described herein, determining a dependence between control signal and fluid temperature. Such embodiment may thus comprise determining, based on the determined dependence, an appropriate control signal for a desired fluid temperature. In an embodiment, the method comprises storing such determined dependence on a computer-readable storage medium, which may be present on or in the acoustic-based particle manipulation device.

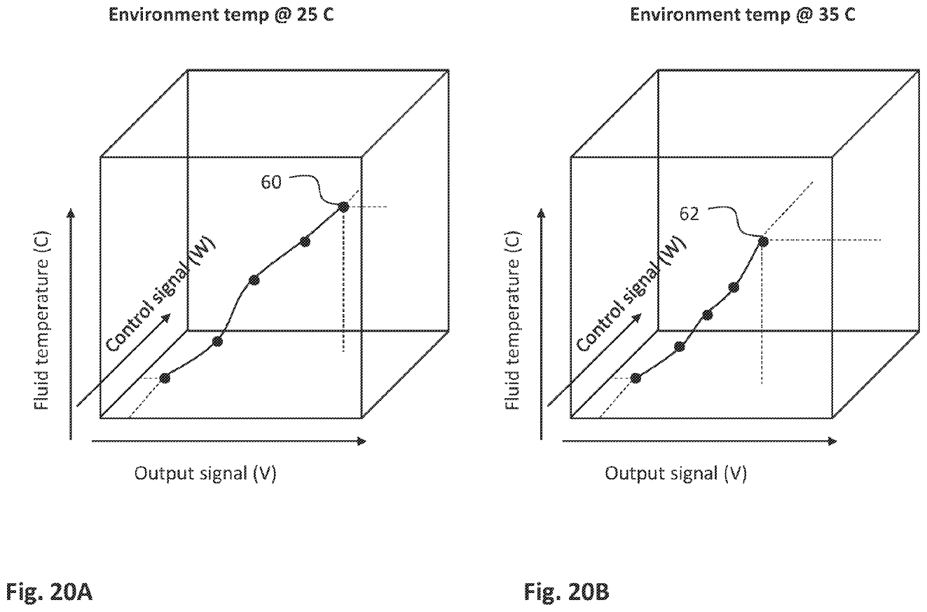

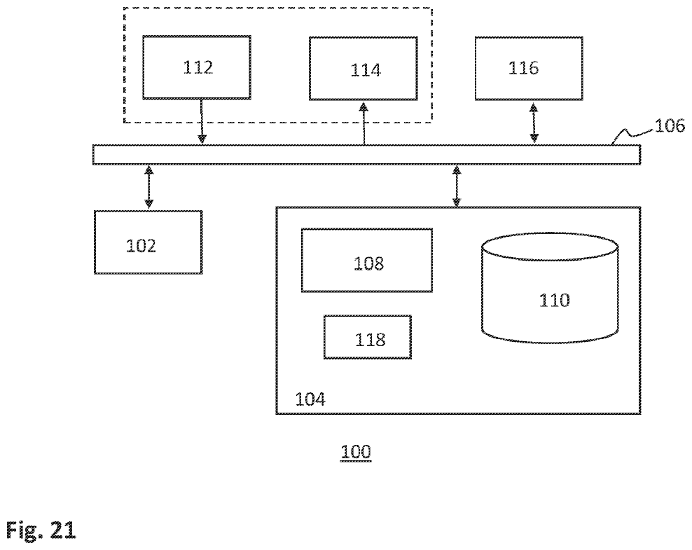

FIG. 20 schematically illustrates the data that may be stored by a computer-readable storage medium according to an embodiment. Graphs 20A as well as graph 20B shows a dependence between control signal, output signal and actual fluid temperature, for different respective environmental temperatures.

The data points in graph 20A can be obtained by performing the method illustrated in FIG. 15, wherein the temperature value is stored in association with both the output signal from the temperature sensor and the actual temperature of the fluid (as determined using the methods described herein). The environmental temperature of the environment in which the acoustic-based particle manipulation device was present when the data points were measured, has also been recorded. For the points in graph 20A, the environmental temperature was 25 degrees Celsius and for the data points in graph 20B, the environmental temperature was 35 degrees Celsius.

It should be appreciated that a lower environmental temperature requires the temperature control system, e.g. local heater structures, to generate more heat to have the fluid reach the same temperature value. This can be seen in graphs 20A and 20B in that data points 60 and 62 have the same fluid temperature, however, data point 60 has a higher power for the control signal than data point 62. When the temperature control system generates a lot of heat, then a higher temperature gradient will arise. As a result, the temperature sensor, which is positioned outside of the holding space and typically closer to the heater structure than the holding space, will output a higher voltage (assuming that a higher voltage corresponds to a higher measured temperature). This is visible in FIG. 20 in that data point 60 has a higher voltage for the output signal than data point 62.

Thus, preferably, when a temperature control system is used for locally heating the fluid inside the holding space, the temperature sensor is calibrated using the method disclosed herein for different environmental temperatures. This ensures that the temperature sensor can be reliably used for any environmental temperature. Preferably, any output signal that is stored in association with fluid temperature for a device that also comprises a temperature control system is stored in association with environmental temperature as well. This allows to determine, based on an output voltage of the temperature sensor and based on a present environmental temperature, the temperature of the fluid inside the holding space without having to determine the resonance frequency (again). This may be advantageous especially if during an experiment different fluids and/or the presence of particles in the holding space affect the resonance frequency and therefore change the dependence of the resonance frequency on the temperature in the holding space.

FIG. 21 depicts a block diagram illustrating a data processing system according to an embodiment.

As shown in FIG. 21, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

The memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a keyboard, a pointing device such as a mouse, a touch-sensitive display, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 21 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

As pictured in FIG. 21, the memory elements 104 may store an application 118. In various embodiments, the application 118 may be stored in the local memory 108, the one or more bulk storage devices 110, or apart from the local memory and the bulk storage devices. It should be appreciated that the data processing system 100 may further execute an operating system (not shown in FIG. 21) that can facilitate execution of the application 118. The application 118, being implemented in the form of executable program code, can be executed by the data processing system 100, e.g., by the processor 102. Responsive to executing the application, the data processing system 100 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 102 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A method for measuring a temperature of a fluid in a holding space of an acoustic-based particle manipulation device, the method comprising
performing a calibration comprising measuring, using a reference temperature sensor, the temperature of the fluid to be a reference temperature value, and determining a reference resonance frequency of the acoustic-based particle manipulation device having the fluid in its holding space at the reference temperature value, and
measuring the temperature of the fluid comprising determining a resonance frequency of the acoustic-based particle manipulation device and determining, based on the reference resonance frequency determined during the calibration and based on the determined resonance frequency, the temperature of the fluid to be a temperature value.

2. The method according to claim 1, wherein the reference resonance frequency and the resonance frequency are associated with a resonance of a subsystem of the acoustic-based particle manipulation device, wherein the fluid in the holding space is part of said subsystem.

3. The method according to claim 1, wherein performing the calibration further comprises
heating or cooling the fluid to a second reference temperature value, and
measuring, using the reference temperature sensor, the temperature of the fluid to be the second reference temperature value, and
determining a second reference resonance frequency of the acoustic-based particle manipulation device having the fluid in its holding space at the second reference temperature value, wherein
determining the temperature of the fluid to be the temperature value is performed based on the determined reference resonance frequency and based on the determined second reference resonance frequency and based on the determined resonance frequency.

4. The method according to claim 3, further comprising
keeping an environment at the reference temperature value, and
heating or cooling the fluid to the reference temperature value comprising inserting the acoustic-based particle manipulation device in said environment so that the temperature of the fluid after some time period has the reference temperature value.

5. The method according to claim 4, wherein measuring the temperature of the fluid to be the reference temperature value and/or the second reference temperature value comprises measuring, using the reference temperature sensor, the temperature of said environment to be the reference temperature value and/or the second reference temperature value.

6. The method according to claim 3, wherein determining the temperature of the fluid to be the temperature value comprises determining a dependence between fluid temperature and resonance frequency of the acoustic-based particle manipulation device based on the reference resonance frequency and the second reference resonance frequency, and
based on the determined resonance frequency and based on said dependence, determining the temperature of the fluid to be the temperature value.

7. The method according to claim 3, wherein determining the reference resonance frequency and/or the second reference resonance frequency and/or the resonance frequency and/or the second resonance frequency comprises
providing a driving signal to the holding space for generating an acoustic wave in the holding space, and
varying a frequency of the driving signal, and
determining that the acoustic-based particle manipulation device exhibits a resonance frequency at respectively the reference resonance frequency and/or the second reference resonance frequency and/or the resonance frequency and/or the second resonance frequency.

8. The method according to claim 7, wherein a power of the driving signal is kept relatively low while varying the frequency of the driving signal in order to prevent heat caused by the driving signal from heating the fluid and herewith substantially distorting the calibration.

9. The method according to claim 1, wherein the acoustic-based particle manipulation device comprises a temperature control system for heating and/or cooling the fluid in the holding space, the method comprising
heating or cooling the fluid in the holding space to said temperature value using the temperature control system by providing a control signal to the temperature control system and then performing said step of measuring the temperature of the fluid to be the temperature value, and
associating said control signal with the temperature value.

10. The method according to claim 9, further comprising
heating or cooling the fluid in the holding space to a second temperature value using the temperature control system by providing a second control signal to the temperature control system and then
measuring the temperature of the fluid comprising determining a second resonance frequency of the acoustic-based particle manipulation device and determining, based on the determined reference resonance frequency during the calibration and based on the determined second resonance frequency, the temperature of the fluid to be the second temperature value, and
associating the second control signal with the second temperature value.

11. The method according to claim 10, further comprising determining a dependence between fluid temperature and control signal based on the first control signal and second control signal.

12. The method according to claim 1, wherein the acoustic-based particle manipulation device comprises a temperature sensor for measuring the temperature at a position outside of the holding space, the method further comprising
receiving an output signal from the temperature sensor indicative of the temperature at said position when said step of determining the resonance frequency of the acoustic-based particle manipulation device is performed, and
associating the output signal with the temperature value.

13. The method according to claim 12, wherein the acoustic-based particle manipulation device comprises a temperature control system for heating and/or cooling the fluid in the holding space, the method comprising
heating or cooling the fluid in the holding space to said temperature value using the temperature control system, and then performing said step of determining the resonance frequency of the acoustic-based particle manipulation device.

14. The method according to the claim 13, wherein the acoustic-based particle manipulation device comprises a temperature control system for heating and/or cooling the fluid in the holding space, the method comprising
heating or cooling the fluid in the holding space to a second temperature value using the temperature control system, and
measuring the temperature of the fluid comprising determining a second resonance frequency of the acoustic-based particle manipulation device and determining, based on the determined reference resonance frequency during the calibration and based on the determined second resonance frequency, the temperature of the fluid to be the second temperature value, and
receiving a second output signal from the temperature sensor indicative of the temperature at said position when said step of determining the second resonance frequency of the acoustic-based particle manipulation device is performed, and
associating the second output signal with the second temperature value.

15. The method according to claim 14, further comprising determining a dependence between fluid temperature and temperature sensor output signal based on the first output signal and second output signal.

16. The method according to claim 15, further comprising storing on a non-transitory computer-readable storage medium
the control signal in association with the temperature value, and/or
the second control signal in association with the second temperature value, and/or
the output signal in association with the temperature value, and/or
the second output signal in association with the second temperature value, and/or
a determined dependence between fluid temperature and control signal based on the first control signal and second control signal,
a determined dependence between fluid temperature and temperature sensor output signal based on the first output signal and second output signal.

17. The method according to claim 16, wherein the acoustic-based particle manipulation device comprises said computer-readable storage medium.

18. A method for calibrating an acoustic-based particle manipulation device, the method comprising
performing the calibration comprising measuring, using a reference temperature sensor, a temperature of a fluid to be a reference temperature value, and determining a reference resonance frequency of the acoustic-based particle manipulation device having the fluid in its holding space at the reference temperature value, and storing on a non-transitory computer-readable storage medium the reference temperature value in association with the reference resonance frequency, and/or
performing the calibration comprising heating or cooling the fluid to a second reference temperature value, and measuring, using the reference temperature sensor, the temperature of the fluid to be the second reference temperature value, and determining a second reference resonance frequency of the acoustic-based particle manipulation device having the fluid in its holding space at the second reference temperature value, wherein determining the temperature of the fluid to be the temperature value is performed based on the determined reference resonance frequency and based on the determined second reference resonance frequency and based on the determined resonance frequency and storing on a non-transitory computer-readable storage medium the reference temperature value in association with the reference resonance frequency and the second reference temperature value in association with the second reference resonance frequency, and/or
performing the calibration comprising heating or cooling the fluid to a second reference temperature value, and measuring, using the reference temperature sensor, the temperature of the fluid to be the second reference temperature value, and determining a second reference resonance frequency of the acoustic-based particle manipulation device having the fluid in its holding space at the second reference temperature value, wherein determining the temperature of the fluid to be the temperature value is performed based on the determined reference resonance frequency and based on the determined second reference resonance frequency and based on the determined resonance frequency, and determining a dependence between fluid temperature and resonance frequency of the acoustic-based particle manipulation device based on the reference resonance frequency and the second reference resonance frequency, and storing on a non-transitory computer-readable storage medium said determined dependence between fluid temperature and resonance frequency.

19. A non-transitory computer-readable storage medium obtainable by performing the method of claim 18.

20. A computer-implemented method comprising
obtaining reference data, the reference data indicating for an acoustic-based particle manipulation device comprising a holding space containing a fluid, for one or more reference temperatures of the fluid one or more respective reference resonance frequencies, and
obtaining measurement data, the measurement data indicating one or more measured resonance frequencies of the acoustic-based particle manipulation device, and
determining, based on the reference data, for each of the one or more measured resonance frequencies indicated by the measurement data, a respective temperature of the fluid.
